(19) United States
(12) Patent Application Publication
(10) Pub. No.: US 2016/0302412 A1
(43) Pub. Date: Oct. 20, 2016

(54) USES OF SALICYLIC ACID

(71) Applicant: UNIVERSITY OF TENNESSEE RESEARCH FOUNDATION, Knoxville, TN (US)

(72) Inventor: CRAIG H. CANADAY, JACKSON, TN (US)

(21) Appl. No.: 15/103,338

(22) PCT Filed: Dec. 17, 2014
(86) PCT No.: PCT/US14/70821

§ 371 Date: Jun. 10, 2016

Related U.S. Application Data
(60) Provisional application No. 61/916,976, filed on Dec. 17, 2013.

(51) Int. Cl. A01N 37/40; C05G 3/02

(52) U.S. Cl. CPC A01N 37/40; C05G 3/02

(57) ABSTRACT

Methods of treating seeds are disclosed herein. Embodiments of the present invention include method of controlling phytopathogenic diseases on seeds of useful plants, wherein such methods include applying to the seeds of fungicidally effective amount of a salicylic acid or an agriculturally acceptable salt thereof. Further embodiments include seeds treated with a plant propagation material protecting composition comprising a fungicidally effective amount of a salicylic acid or an agriculturally acceptable salt thereof, together with a suitable carrier.

### CROSS-REFERENCE TO RELATED APPLICATION

This application claims the benefit of U.S. Provisional Application Ser. No. 61/916,976, filed Dec. 17, 2013, the disclosure of which is hereby incorporated by reference in its entirety, including all figures, tables and amino acid or nucleic acid sequences.

### FIELD OF THE INVENTION

This invention relates to a method of preventing damage to the seed and/or shoots and foliage of a plant by a plant pathogen or a pest includes treating the seed from which the plant grows with a composition that includes a combination of a salicylic acid supplemented seed treatment. A method of increasing yield in crop plants (including varieties resistant to seedling disease), such as soybeans and snap beans, is also provided. The treatment may be applied to the unsown seed.

### BACKGROUND OF THE INVENTION

Several studies have indicated that the commonly used potash fertilizer, muriate of potash, can increase losses of snap bean and soybean to seedling diseases. For example, potassium chloride, the most commonly used fertilizer for both these crops, can increase seedling disease losses. Subsequent studies suggest that this may be due to a loss in root calcium. It would be beneficial to improve upon snap bean and soybean seedling disease control by increasing seedling root calcium levels.

### SUMMARY OF THE INVENTION

Embodiments of the present invention include method of controlling phytopathogenic diseases on seeds of useful plants, wherein such methods include applying to the seeds a fungicidally effective amount of a salicylic acid or an agriculturally acceptable salt thereof.

Further embodiments include seeds treated with a plant propagation material protecting composition comprising a fungicidally effective amount of a salicylic acid or an agriculturally acceptable salt thereof, together with a suitable carrier.

Additional embodiments of the present invention include methods of treating a subject suffering from or susceptible to a fungal disease, wherein the method comprises administering to a subject an effective amount of a salicylic acid compound or an agriculturally acceptable salt thereof.

The present invention also includes methods of controlling plant pathogens comprising administering a composition comprising an effective amount of a salicylic acid or an agriculturally acceptable salt thereof to a seed, to a foliar surface of a plant, or to a locus of the plant or seed.

Other embodiments of the present invention include methods for improving the health or propagation of a plant or seed of a plant by applying an effective amount of sodium salicylate or calcium salicylate.

Embodiments of the present invention can also include compositions comprising an effective amount of a salicylic acid or an agriculturally acceptable salt and further comprising adding at least one additional fungicide, herbicide, or insecticide, bactericide, acaracide, nematicide, plant growth regulator, fertilizer, or plant nutrients to said composition.

### DETAILED DESCRIPTION OF THE INVENTION

The present invention relates to treating seeds. The present invention includes methods of use of a composition as described herein for seed treating, nutrition, increasing crop yields and/or for reducing susceptibility to disease of a plant are further disclosed. The composition can be applied to a crop, a single plant (e.g., a houseplant or garden ornamental) or to an assemblage of plants occupying an area. In some embodiments, the composition is applied to an agricultural or horticultural crop, more especially a food crop. A “food crop” herein means a crop grown primarily for human consumption, such as a vegetable crop or fruit crop. Methods of the present invention are appropriate both for field use and in protected cultivation, for example, greenhouse use.

Methods of using various compositions disclosed and described herein comprise applying a composition as described herein to a seed, to a foliar surface of a plant, or to a locus of the plant or seed.

The term “agriculturally acceptable” applied to a material or composition herein means not unacceptably damaging or toxic to a plant or its environment.

A “foliar surface” herein is typically a leaf surface, but other green parts of plants have surfaces that may permit absorption of active ingredient, including petioles, stipules, stems, bracts, flowerbuds, etc., and for present purposes “foliar surfaces” will be understood to include surfaces of such green parts.

A “locus” as used herein is inclusive of a foliar surface and also includes an area in proximity to a plant or the area in which a plurality of seed is or can be sown.

“Seed treatment” as used herein refers generally to contacting a seed with a compound or composition of matter containing or comprising at least one active ingredient (a.i. or AI). The compound or composition of matter may be in any form suitable to the seed, for example, liquid, gel, emulsion, suspension, dispersion, spray, or powder. Seed treatment is inclusive of seed coating and seed dressing.

“Seed coating” or “seed dressing” as used herein refers generally to a coating or matrix formed on at least part of the seed, the coating or matrix containing or comprising the at least one AI. Optional compounds or agents may be included in the seed coating to facilitate the seed coating process or the disintegration/releasing of the at least one AI from the coating, or to prevent excessive dust-off or to add color to the treated seed.

The term “seed” as used herein, is not limited to any particular type of seed and can refer to seed from a single plant species, a mixture of seed from multiple plant species, or a seed blend from various strains within a plant species. The disclosed and described compositions can be utilized to treat gymnosperm seed, dicotyledonous angiosperm seed and monocotyledonous angiosperm seed.

The term “about” is used in this patent application to describe some quantitative aspects of the invention, for example, amounts of salicylic acid or agricultrually acceptable salts thereof. It should be understood that absolute accuracy is not required with respect to those aspects for the invention to operate. When the term “about” is used to describe a quantitative aspect of the invention the relevant aspect may be varied by up to ±10% (e.g., ±1%, ±2%, ±3%, ±4%, ±5%, ±6%, ±7%, ±8%, ±9%, or ±10%).

While the present methods can be beneficial for all types of crops including gramineous (belonging to the grass family) crops such as cereal crops, including corn, wheat, barley, oats and rice, and non-gramineous crops, including vegetable crops, fruit crops, broad-leaved field crops such as soybeans, snap beans, seed crops or a crop of any species grown specially to produce seed. The terms “fruit” and “vegetable” herein are used in their agricultural or culinary sense, not in a strict botanical sense; for example, tomatoes, cucumbers and zucchini are considered vegetables for present purposes, although botanically speaking it is the fruit of these crops that is consumed.

Vegetable crops for which the present methods can be found useful include without limitation: leafy and salad vegetables such as amaranth, beet greens, bitterleaf, bok Choy, Brussels sprout, cabbage, catsear, celtuce, choukwee, Ceylon spinach, chicory, Chinese mallow, chrysanthemum leaf, corn salad, cress, dandelion, endive, epazote, fat hen, fiddlehead, fluted pumpkin, golden samphire, Good King Henry, ice plant, jambu, kai-lan, kale, komatsuna, kuka, Lagos bologi, land cress, lettuce, lizard's tail, melokhia, mizuna greens, mustard, Chinese cabbage, New Zealand spinach, orache, pea leaf, polk, radicchio, rocket (arugula), samphire, sea beet, seakale, Sierra Leone bologi, soko, sorrel, spinach, summer purslane, Swiss chard, tatsoi, turnip greens, watercress, water spinach, winter purslane and you Choy; flowering and fruiting vegetables such as acorn squash, Armenian cucumber, avocado, bell pepper, bitter melon, butternut squash, caigua, Cape gooseberry, cayenne pepper, chayote, chili pepper, cucumber, eggplant (aubergine), globe artichoke, luffa, Malabar gourd, parwal, pattypan squash, perennial cucumber, pumpkin, snake gourd, squash (marrow), sweetcorn, sweet pepper, tinda, tomato, tomatillo, winter melon, West Indian gherkin and zucchini (courgette); podded vegetables (legumes) such as American groundnut, azuki bean, black bean, black-eyed pea, chickpea (garbanzo bean), drumstick, dolichos bean, fava bean (broad bean), French bean, guar, haricot bean, horse gram, Indian pea, kidney bean, lentil, lima bean, moth bean, mung bean, navy bean, okra, pea, peanut (groundnut), pigeon pea, pinto bean, rice bean, runner bean, soybean, tarwi, tepary bean, urad bean, velvet bean, winged bean and yardlong bean; bulb and stem vegetables such as asparagus, cardoon, celeriac, celery, elephant garlic, fennel, garlic, kohlrabi, kurrat, leek, lotus root, nopal, onion, Prussian asparagus, shallot, Welsh onion and wild leek; root and tuber vegetables, such as ahipa, arracacha, bamboo shoot, beetroot, black cumin, burdock, broadleaf arrowhead, camas, canna, carrot, cassava, Chinese artichoke, daikon, earthnut pea, elephant-foot yam, ensete, ginger, gobo, Hamburg parsley, horseradish, Jerusalem artichoke, jicama, parsnip, pignut, plectranthus, potato, prairie turnip, radish, rutabaga (swede), salsify, scorzonera, skirret, sweet potato, taro, ti, tigernut, turnip, ulluco, wasabi, water chestnut, yacon and yam; and herbs, such as angelica, anise, basil, bergamot, caraway, cardamom, chamomile, chives, cilantro, coriander, dill, fennel, ginseng, jasmine, lavender, lemon balm, lemon basil, lemongrass, marjoram, mint, oregano, parsley, poppy, saffron, sage, star anise, tarragon, thyme, turmeric and vanilla.

Fruit crops for which the present methods can be found useful include without limitation apple, apricot, banana, blackberry, blackcurrant, blueberry, boysenberry, cantaloupe, cherry, citron, clementine, cranberry, damson, dragonfruit, fig, grape, grapefruit, greengage, gooseberry, guava, honeydew, jackfruit, key lime, kiwifruit, kumquat, lemon, lime, loganberry, longan, loquat, mandarin, mango, mangosteen, melon, muskmelon, orange, papaya, peach, pear, persimmon, pineapple, plantain, plum, pomelo, prickly pear, quince, raspberry, redcurrant, starfruit, strawberry, tangelo, tangerine, tayberry, ugli fruit and watermelon.

Seed crops, for example, specialized crops used to produce seed of any plant species, for which the present methods can be found useful include, in addition to cereals (e.g., barley, corn (maize), millet, oats, rice, rye, sorghum (milo) and wheat), non-gramineous seed crops such as soybeans, snap beans, cotton, flaxseed (linseed), mustard, poppy, rapeseed (including canola), safflower, sesame and sunflower.

Other crops, not fitting any of the above categories, for which the present methods can be found useful include without limitation sugar beet, sugar cane, hops and tobacco.

Each of the crops listed above has its own particular nutrition and disease protection needs. Further optimization of compositions described herein for particular crops can readily be undertaken by those of skill in the art, based on the present disclosure, without undue experimentation.

Compositions disclosed and described herein can be applied using any conventional system for applying liquid or solid to a seed or foliar surface or locus. Most commonly, application by spraying will be found most convenient, but other techniques, including application by tumbling, brush or by rope-wick can be used if desired. For spraying, any conventional atomization method can be used to generate spray droplets, including hydraulic nozzles and rotating disk atomizers. Introduction of the composition into an irrigation system can be used.

For foliage surface or locus applications, the application rate of the composition can be between about 0.01 gram/hectare to about 10.0 gram/hectare dry weight, between about 0.2 gram/hectare to about 2.0 gram/hectare dry weight, between 0.3 gram/hectare to about 1.5 gram/hectare dry weight, or between about 0.4 gram/hectare to about 1.0 gram/hectare dry weight applied in the soil or as a foliar application to the foliage or the locus of the plant.

Compositions disclosed and described herein can be provided in concentrate form, (e.g., liquid, gel, or reconstitutable powder form), suitable for further dilution and/or mixing in water prior to application to the seed, plant, or locus. Alternatively, they can be provided as a ready-to-use solution for direct application. Because compositions disclosed and described herein can be combined with other fertilizer solutions and/or with pesticide solutions, they can be diluted and/or reconstituted by mixing with such other solutions.

The above concentrate compositions are suitable for further dilution. For application to plant foliage, a concentrate composition can be diluted up to about 600-fold or more with water, more typically up to about 100-fold or up to about 40-fold. Illustratively, a concentrate product can be applied at about 0.1 to about 30 l/ha, for example about 5 to about 25 l/ha, in a total application volume after dilution of about 60 to about 600 l/ha, for example about 80 to about 400 l/ha or about 100 to about 200 l/ha.

For seed treatment applications, a concentrate composition can be diluted up to about 600-fold or more with water, more typically up to about 100-fold or up to about 40-fold. Illustratively, a concentrate product can be applied at about 0.1 mg/Kg seed to about 100 mg/Kg seed, for example about 0.1 mg/Kg seed, 0.5 mg/Kg seed, 0.75 mg/Kg seed, 1.0 mg/Kg seed, 1.25 mg/Kg seed, 1.5 mg/Kg seed, 1.75 mg/Kg seed, 2.0 mg/Kg seed, 2.5 mg/Kg seed, 3.0 mg/Kg seed, 3.5 mg/Kg seed, 4.0 mg/Kg seed, 4.5 mg/Kg seed, 5.0 mg/Kg seed, 5.5 mg/Kg seed, 6.0 mg/Kg seed, 6.5 mg/Kg seed, 7.0 mg/Kg seed, 7.5 mg/Kg seed, 8.0 mg/Kg seed, 8.5 mg/Kg seed, 9.0 mg/Kg seed, 9.5 mg/Kg seed, and 10.0 mg/Kg seed. A concentrate product can also be applied at about 15 mg/Kg, 20 mg/Kg, 25 mg/Kg, and 30 mg/Kg.

Application solutions prepared by diluting concentrate compositions as described above represent further aspects of the compositions and methods disclosed and described herein.

The salicylic acid or agriculturally acceptable salt that can be used can include supplementation with a calcium or sodium based product such as calcium lactate, calcium formate, calcium nitrate, calcium salicylate, sodium lactate, sodium formate, sodium nitrate, or sodium salicylate. Generally, a salicylic acid compound is preferred.

The present invention includes a composition comprising a compound of the invention, or an agriculturally acceptable salt thereof, and an agriculturally acceptable carrier or diluent. Said agricultural composition typically contains up to 85 wt % of a compound of the invention. More typically, it contains up to 50 wt % of a compound of the invention.

Suitable agriculturally acceptable salts include salts with agriculturally acceptable acids, both inorganic acids such as hydrochloric, sulphuric, phosphoric, diphosphoric, hydrobromic or nitric acid and organic acids such as citric, fumaric, maleic, malic, ascorbic, succinic, tartaric, benzoic, acetic, methanesulphonic, ethanesulphonic, benzenesulphonic or p-toluenesulphonic acid. Salts may also be formed with agriculturally acceptable bases such as alkali metal (e.g. sodium or potassium) and alkaline earth metal (e.g. calcium or magnesium) hydroxides and organic bases such as alkyl amines, aralkyl amines or heterocyclic amines.

Such compounds can be used to treat fungal diseases of plants which can be controlled using the compounds of the invention include fungal diseases caused by the following plant pathogens: Blumeria graminis; Colletotrichium trifolii; Fusarium graminarium; Fusarium solani; Fusarium sporotrichoides; Leptosphaeria nodorum; Macrophomina phaseolina, Magnaporthe grisea; Mycosphaerella graminicola; Neurospora crassa; Phytophthora capsici; Phytophthora infestans; Plasmopara viticola; Puccinia coronata; Puccinia graminis; Pyricularia oryzae; Pythium ultimum; Rhizoctonia solani; Trichophyton rubrum; and Ustilago maydis.

In one aspect of the present invention, methods of promoting healthy growth of plant seeds is provided that comprises contacting the seeds with an aqueous composition comprising the salicylic acid or agriculturally acceptable salt and optionally a second component selected from one or more pesticides and/or one or more natural plant hormones. The seeds may be contacted with the aqueous composition by conventional means such as spraying, rolling, or tumbling.

### Fungicides

In embodiments of the present invention, an effective seed treatment or foliar treatment can comprise a seed treated or foliar surface with a combination comprising the salicylic acid or agriculturally acceptable salt as used in combination (such as, in a compositional mixture, or a simultaneous or sequential application) with one or more of the following fungicides-(3-ethoxypropyl)mercury bromide, 2-methoxyethylmercury chloride, 2-phenylphenol, 8-hydroxyquinoline sulfate, 8-phenylmercurioxyquinoline, acibenzolar, acibenzolar-S-methyl, acypetacs, acypetacs-copper, acypetacs-zinc, aldimorph, allyl alcohol, ametoctradin, amisulbrom, ampropylfos, anilazine, aureofungin, azaconazole, azithiram, azoxystrobin, barium polysulfide, benalaxyl, benalaxyl-M, benodanil, benomyl, benquinox, bentaluron, benthiavalicarb, benthiavalicarb-isopropyl, benzalkonium chloride, benzamacril, benzamacril-isobutyl, benzamorf, benzohydroxamic acid, bethoxazin, binapacryl, biphenyl, bitertanol, bithionol, bixafen, blasticidin-S, Bordeaux mixture, boscalid, bromuconazole, bupirimate, Burgundy mixture, buthiobate, butylamine, calcium polysulfide, captafol, captan, carbamorph, carbendazim, carboxin, carpropamid, carvone, Cheshunt mixture, chinomethionat, chlobenthiazone, chloraniformethan, chloranil, chlorfenazole, chlorodinitronaphthalene, chloroneb, chloropicrin, chlorothalonil, chlorquinox, chlozolinate, climbazole, clotrimazole, copper acetate, copper carbonate, basic, copper hydroxide, copper naphthenate, copper oleate, copper oxychloride, copper silicate, copper sulfate, copper zinc chromate, cresol, cufraneb, cuprobam, cuprous oxide, cyazofamid, cyclafuramid, cycloheximide, cyflufenamid, cymoxanil, cypendazole, cyproconazole, cyprodinil, dazomet, dazomet-sodium, DBCP, debacarb, decafentin, dehydroacetic acid, dichlofluanid, dichlone, dichlorophen, dichlozoline, diclobutrazol, diclocymet, diclomezine, diclomezine-sodium, dicloran, diethofencarb, diethyl pyrocarbonate, difenoconazole, diflumetorim, dimethirimol, dimethomorph, dimoxystrobin, diniconazole, diniconazole-M, dinobuton, dinocap, dinocap-4, dinocap-6, dinocton, dinopenton, dinosulfon, dinoterbon, diphenylamine, dipyrithione, disulfuram, ditalimfos, dithianon, DNOC, DNOC-ammonium, DNOC-potassium, DNOC-sodium, dodemorph, dodemorph acetate, dodemorph benzoate, dodicin, dodicin-sodium, dodine, drazoxolon, edifenphos, epoxiconazole, etaconazole, etem, ethaboxam, ethirimol, ethoxyquin, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, fentin chloride, fentin hydroxide, ferbam, ferimzone, fluazinam, fludioxonil, flumetover, flumorph, fluopicolide, fluopyram, fluoroimide, fluotrimazole, fluoxastrobin, fluquinconazole, flusilazole, flusulfamide, flutianil, flutolanil, flutriafol, fluxapyroxad, folpet, formaldehyde, fosetyl, fosetyl-aluminium, fuberidazole, furalaxyl, furametpyr, furcarbanil, furconazole, furconazole-cis, furfural, furmecyclox, furophanate, glyodin, griseofulvin, guazatine, halacrinate, hexachlorobenzene, hexachlorobutadiene, hexaconazole, hexylthiofos, hydrargaphen, hymexazol, imazalil, imazalil nitrate, imazalil sulfate, imibenconazole, iminoctadine, iminoctadine triacetate, iminoctadine trialbesilate, iodomethane, ipconazole, iprobenfos, iprodione, iprovalicarb, isoprothiolane, isopyrazam, isotianil, isovaledione, kasugamycin, kresoxim-methyl, mancopper, mancozeb, mandipropamid, maneb, mebenil, mecarbinzid, mepanipyrim, mepronil, meptyldinocap, mercuric chloride, mercuric oxide, mercurous chloride, metalaxyl, metalaxyl-M, metam, metam-ammonium, metam-potassium, metam-sodium, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, myclobutanil, myclozolin, N-(ethylmercury)-p-toluenesulphonanilide, nabam, natamycin, nitrostyrene, nitrothal-isopropyl, nuarimol, OCH, octhilinone, ofurace, orysastrobin, oxadixyl, oxine-copper, oxpoconazole, oxpoconazole fumarate, oxycarboxin, pefurazoate, penconazole, pencycuron, penflufen, pentachlorophenol, penthiopyrad, phenylmercuriurea, phenylmercury acetate, phenylmercury chloride, phenylmercury derivative of pyrocatechol, phenylmercury nitrate, phenylmercury salicylate, phosdiphen, phthalide, picoxystrobin, piperalin, polycarbamate, polyoxins, polyoxorim, polyoxorim-zinc, potassium azide, potassium polysulfide, potassium thiocyanate, probenazole, prochloraz, procymidone, propamocarb, propamocarb hydrochloride, propiconazole, propineb, proquinazid, prothiocarb, prothiocarb hydrochloride, prothioconazole, pyracarbolid, pyraclostrobin, pyraclostrobin, pyrametostrobin, pyraoxystrobin, pyrazophos, pyribencarb, pyridinitril, pyrifenox, pyrimethanil, pyriofenone, pyroquilon, pyroxychlor, pyroxyfur, quinacetol, quinacetol sulfate, quinazamid, quinconazole, quinoxyfen, quintozene, rabenzazole, salicylanilide, sedaxane, silthiofam, simeconazole, sodium azide, sodium orthophenylphenoxide, sodium pentachlorophenoxide, sodium polysulfide, spiroxamine, streptomycin, sulfur, sultropen, TCMTB, tebuconazole, tebufloquin, tecloftalam, tecnazene, tecoram, tetraconazole, thiabendazole, thiadifluor, thicyofen, thifluzamide, thiochlorfenphim, thiomersal, thiophanate, thiophanate-methyl, thioquinox, thiram, tiadinil, tioxymid, tolclofos-methyl, tolylfluanid, tolylmercury acetate, triadimefon, triadimenol, triamiphos, triarimol, triazbutil, triazoxide, tributyltin oxide, trichlamide, tricyclazole, tridemorph, trifloxystrobin, triflumizole, triforine, triticonazole, uniconazole, uniconazole-P, validamycin, valifenalate, vinclozolin, zarilamid, zinc naphthenate, zineb, ziram, zoxamide (collectively these commonly named fungicides are defined as the “Fungicide Group”).

### Insecticides

In embodiments of the present invention, an effective seed treatment or foliar treatment can comprise a seed treated or foliar surface with a combination comprising the salicylic acid or agriculturally acceptable salt as used in combination (such as, in a compositional mixture, or a simultaneous or sequential application) with one or more of the following insecticides-1,2-dichloropropane, abamectin, acephate, acetamiprid, acethion, acetoprole, acrinathrin, acrylonitrile, alanycarb, aldicarb, aldoxycarb, aldrin, allethrin, allosamidin, allyxycarb, α-cypermethrin, a/pha-ecdysone, a/pha-endosulfan, amidithion, aminocarb, amiton, amiton oxalate, amitraz, anabasine, athidathion, azadirachtin, azamethiphos, azinphos-ethyl, azinphos-methyl, azothoate, barium hexafluorosilicate, barthrin, bendiocarb, benfuracarb, bensultap, beta-cyfluthrin, beta-cypermethrin, bifenthrin, bioallethrin, bioethanomethrin, biopermethrin, bistrifluoron, borax, boric acid, bromfenvinfos, bromocyclen, bromo-DDT, bromophos, bromophos-ethyl, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, cartap hydrochloride, chlorantraniliprole, chlorbicyclen, chlordane, chlordecone, chlordimeform, chlordimeform hydrochloride, chlorethoxyfos, chlorfenapyr, chlorfenvinphos, chlorfluazuron, chlormephos, chloroform, chloropicrin, chlorphoxim, chlorprazophos, chlorpyrifos, chlorpyrifos-methyl, chlorthiophos, chromafenozide, cinerin I, cinerin II, cinerins, cismethrin, cloethocarb, closantel, clothianidin, copper acetoarsenite, copper arsenate, copper naphthenate, copper oleate, coumaphos, coumithoate, crotamiton, crotoxyphos, crufomate, cryolite, cyanofenphos, cyanophos, cyanthoate, cyantraniliprole, cyclethrin, cycloprothrin, cyfluthrin, cyhalothrin, cypermethrin, cyphenothrin, cyromazine, cythioate, DDT, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, diatomaceous earth, diazinon, dicapthon, dichlofenthion, dichlorvos, dicresyl, dicrotophos, dicyclanil, dieldrin, diflubenzuron, dilor, dimefluthrin, dimefox, dimetan, dimethoate, dimethrin, dimethylvinphos, dimetilan, dinex, dinex-diclexine, dinoprop, dinosam, dinotefuran, diofenolan, dioxabenzofos, dioxacarb, dioxathion, disulfoton, dithicrofos, d-limonene, DNOC, DNOC-ammonium, DNOC-potassium, DNOC-sodium, doramectin, ecdysterone, emamectin, emamectin benzoate, EMPC, empenthrin, endosulfan, endothion, endrin, EPN, epofenonane, eprinomectin, esdepallethrine, esfenvalerate, etaphos, ethiofencarb, ethion, ethiprole, ethoate-methyl, ethoprophos, ethyl formate, ethyl-DDD, ethylene dibromide, ethylene dichloride, ethylene oxide, etofenprox, etrimfos, EXD, famphur, fenamiphos, fenazaflor, fenchlorphos, fenethacarb, fenfluthrin, fenitrothion, fenobucarb, fenoxacrim, fenoxycarb, fenpirithrin, fenpropathrin, fensulfothion, fenthion, fenthion-ethyl, fenvalerate, fipronil, flonicamid, flubendiamide (additionally resolved isomers thereof), flucofuron, flucycloxuron, flucythrinate, flufenerim, flufenoxuron, flufenprox, fluvalinate, fonofos, formetanate, formetanate hydrochloride, formothion, formparanate, formparanate hydrochloride, fosmethilan, fospirate, fosthietan, fufenozide, furathiocarb, furethrin, gamma-cyhalothrin, gamma-HCH, halfenprox, halofenozide, HCH, HEOD, heptachlor, heptenophos, heterophos, hexaflumuron, HHDN, hydramethylnon, hydrogen cyanide, hydroprene, hyquincarb, imidacloprid, imiprothrin, indoxacarb, iodomethane, IP SP, isazofos, isobenzan, isocarbophos, isodrin, isofenphos, isofenphos-methyl, isoprocarb, isoprothiolane, isothioate, isoxathion, ivermectin, jasmolin I, jasmolin II, jodfenphos, juvenile hormone I, juvenile hormone II, juvenile hormone III, kelevan, kinoprene, lambda-cyhalothrin, lead arsenate, lepimectin, leptophos, lindane, lirimfos, lufenuron, lythidathion, malathion, malonoben, mazidox, mecarbam, mecarphon, menazon, meperfluthrin, mephosfolan, mercurous chloride, mesulfenfos, metaflumizone, methacrifos, methamidophos, methidathion, methiocarb, methocrotophos, methomyl, methoprene, methothrin, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, molosultap, monocrotophos, monomehypo, monosultap, morphothion, moxidectin, naftalofos, naled, naphthalene, nicotine, nifluridide, nitenpyram, nithiazine, nitrilacarb, novaluron, noviflumuron, omethoate, oxamyl, oxydemeton-methyl, oxydeprofos, oxydisulfoton, para-dichlorobenzene, parathion, parathion-methyl, penfluoron, pentachlorophenol, permethrin, phenkapton, phenothrin, phenthoate, phorate, phosalone, phosfolan, phosmet, phosnichlor, phosphamidon, phosphine, phoxim, phoxim-methyl, pirimetaphos, pirimicarb, pirimiphos-ethyl, pirimiphos-methyl, potassium arsenite, potassium thiocyanate, pp′-DDT, prallethrin, precocene I, precocene II, precocene III, primidophos, profenofos, profluralin, profluthrin, promacyl, promecarb, propaphos, propetamphos, propoxur, prothidathion, prothiofos, prothoate, protrifenbute, pymetrozine, pyraclofos, pyrafluprole, pyrazophos, pyresmethrin, pyrethrin I, pyrethrin II, pyrethrins, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, rotenone, ryania, sabadilla, schradan, selamectin, silafluofen, silica gel, sodium arsenite, sodium fluoride, sodium hexafluorosilicate, sodium thiocyanate, sophamide, spinetoram, spinosad, spiromesifen, spirotetramat, sulcofuron, sulcofuron-sodium, sulfluramid, sulfotep, sulfoxaflor, sulfuryl fluoride, sulprofos, tau-fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetramethrin, tetramethylfluthrin, theta-cypermethrin, thiacloprid, thiamethoxam, thicrofos, thiocarboxime, thiocyclam, thiocyclam oxalate, thiodicarb, thiofanox, thiometon, thiosultap, thiosultap-disodium, thiosultap-monosodium, thuringiensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb, zeta-cypermethrin, and zolaprofos (collectively these commonly named insecticides are defined as the “Insecticide Group”).

### Acaricides

In embodiments of the present invention, an effective seed treatment or foliar treatment can comprise a seed treated or foliar surface with a combination comprising the salicylic acid or agriculturally acceptable salt as used in combination (such as, in a compositional mixture, or a simultaneous or sequential application) with one or more of the following acaricides-acequinocyl, amidoflumet, arsenous oxide, azobenzene, azocyclotin, benomyl, benoxafos, benzoximate, benzyl benzoate, bifenazate, binapacryl, bromopropylate, chinomethionat, chlorbenside, chlorfenethol, chlorfenson, chlorfensulphide, chlorobenzilate, chloromebuform, chloromethiuron, chloropropylate, clofentezine, cyenopyrafen, cyflumetofen, cyhexatin, dichlofluanid, dicofol, dienochlor, diflovidazin, dinobuton, dinocap, dinocap-4, dinocap-6, dinocton, dinopenton, dinosulfon, dinoterbon, diphenyl sulfone, disulfuram, dofenapyn, etoxazole, fenazaquin, fenbutatin oxide, fenothiocarb, fenpyroximate, fenson, fentrifanil, fluacrypyrim, fluazuron, flubenzimine, fluenetil, flumethrin, fluorbenside, hexythiazox, mesulfen, MNAF, nikkomycins, proclonol, propargite, quintiofos, spirodiclofen, sulfuram, sulfur, tetradifon, tetranactin, tetrasul, and thioquinox (collectively these commonly named acaricides are defined as the “Acaricide Group”).

### Nematicides

In embodiments of the present invention, an effective seed treatment or foliar treatment can comprise a seed treated or foliar surface with a combination comprising the salicylic acid or agriculturally acceptable salt as used in combination (such as, in a compositional mixture, or a simultaneous or sequential application) with one or more of the following nematicides-1,3-dichloropropene, benclothiaz, dazomet, dazomet-sodium, DBCP, DCIP, diamidafos, fluensulfone, fosthiazate, furfural, imicyafos, isamidofos, isazofos, metam, metam-ammonium, metam-potassium, metam-sodium, phosphocarb, and thionazin (collectively these commonly named nematicides are defined as the “Nematicide Group”).

In embodiments of the present invention, an effective seed treatment or foliar treatment can comprise a seed treated or foliar surface with a combination comprising the salicylic acid or agriculturally acceptable salt as used in combination (such as, in a compositional mixture, or a simultaneous or sequential application) with one or more of the following herbicides-2,3,6-TBA, 2,3,6-TBA-dimethylammonium, 2,3,6-TBA-sodium, 2,4,5-T, 2,4,5-T-2-butoxypropyl, 2,4,5-T-2-ethylhexyl, 2,4,5-T-3-butoxypropyl, 2,4,5-TB, 2,4,5-T-butomethyl, 2,4,5-T-butotyl, 2,4,5-T-butyl, 2,4,5-T-isobutyl, 2,4,5-T-isoctyl, 2,4,5-T-isopropyl, 2,4,5-T-methyl, 2,4,5-T-pentyl, 2,4,5-T-sodium, 2,4,5-T-triethylammonium, 2,4,5-T-trolamine, 2,4-D, 2,4-D-2-butoxypropyl, 2,4-D-2-ethylhexyl, 2,4-D-3-butoxypropyl, 2,4-D-ammonium, 2,4-DB, 2,4-DB-butyl, 2,4-DB-dimethylammonium, 2,4-DB-isoctyl, 2,4-DB-potassium, 2,4-DB-sodium, 2,4-D-butotyl, 2,4-D-butyl, 2,4-D-diethylammonium, 2,4-D-dimethylammonium, 2,4-D-diolamine, 2,4-D-dodecylammonium, 2,4-DEB, 2,4-DEP, 2,4-D-ethyl, 2,4-D-heptylammonium, 2,4-D-isobutyl, 2,4-D-isoctyl, 2,4-D-isopropyl, 2,4-D-isopropylammonium, 2,4-D-lithium, 2,4-D-meptyl, 2,4-D-methyl, 2,4-D-octyl, 2,4-D-pentyl, 2,4-D-potassium, 2,4-D-propyl, 2,4-D-sodium, 2,4-D-tefuryl, 2,4-D-tetradecylammonium, 2,4-D-triethylammonium, 2,4-D-tris(2-hydroxypropyl)ammonium, 2,4-D-trolamine, 3,4-DA, 3,4-DB, 3,4-DP, 4-CPA, 4-CPB, 4-CPP, acetochlor, acifluorfen, acifluorfen-methyl, acifluorfen-sodium, aclonifen, acrolein, alachlor, allidochlor, alloxydim, alloxydim-sodium, allyl alcohol, alorac, ametridione, ametryn, amibuzin, amicarbazone, amidosulfuron, aminocyclopyrachlor, aminocyclopyrachlor-methyl, aminocyclopyrachlor-potassium, aminopyralid, aminopyralid-potassium, aminopyralid-tris(2-hydroxypropyl)ammonium, amiprofos-methyl, amitrole, ammonium sulfamate, anilofos, anisuron, asulam, asulam-potassium, asulam-sodium, atraton, atrazine, azafenidin, azimsulfuron, aziprotryne, barban, BCPC, beflubutamid, benazolin, benazolin-dimethylammonium, benazolin-ethyl, benazolin-potassium, bencarbazone, benfluralin, benfuresate, bensulfuron, bensulfuron-methyl, bensulide, bentazone, bentazone-sodium, benzadox, benzadox-ammonium, benzfendizone, benzipram, benzobicyclon, benzofenap, benzofluor, benzoylprop, benzoylprop-ethyl, benzthiazuron, bicyclopyrone, bifenox, bilanafos, bilanafos-sodium, bispyribac, bispyribac-sodium, borax, bromacil, bromacil-lithium, bromacil-sodium, bromobonil, bromobutide, bromofenoxim, bromoxynil, bromoxynil butyrate, bromoxynil heptanoate, bromoxynil octanoate, bromoxynil-potassium, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, carfentrazone, carfentrazone-ethyl, CDEA, CEPC, chlomethoxyfen, chloramben, chloramben-ammonium, chloramben-diolamine, chloramben-methyl, chloramben-methylammonium, chloramben-sodium, chloranocryl, chlorazifop, chlorazifop-propargyl, chlorazine, chlorbromuron, chlorbufam, chloreturon, chlorfenac, chlorfenac-sodium, chlorfenprop, chlorfenprop-methyl, chlorflurazole, chlorflurenol, chlorflurenol-methyl, chloridazon, chlorimuron, chlorimuron-ethyl, chlornitrofen, chloropon, chlorotoluron, chloroxuron, chloroxynil, chlorprocarb, chlorpropham, chlorsulfuron, chlorthal, chlorthal-dimethyl, chlorthal-monomethyl, chlorthiamid, cinidon-ethyl, cinmethylin, cinosulfuron, cisanilide, clethodim, cliodinate, clodinafop, clodinafop-propargyl, clofop, clofop-isobutyl, clomazone, clomeprop, cloprop, cloproxydim, clopyralid, clopyralid-methyl, clopyralid-olamine, clopyralid-potassium, clopyralid-tris(2-hydroxypropyl)ammonium, cloransulam, cloransulam-methyl, CMA, copper sulfate, CPMF, CPPC, credazine, cresol, cumyluron, cyanamide, cyanatryn, cyanazine, cycloate, cyclosulfamuron, cycloxydim, cycluron, cyhalofop, cyhalofop-butyl, cyperquat, cyperquat chloride, cyprazine, cyprazole, cypromid, daimuron, dalapon, dalapon-calcium, dalapon-magnesium, dalapon-sodium, dazomet, dazomet-sodium, delachlor, desmedipham, desmetryn, di-allate, dicamba, dicamba-dimethylammonium, dicamba-diolamine, dicamba-isopropylammonium, dicamba-methyl, dicamba-olamine, dicamba-potassium, dicamba-sodium, dicamba-trolamine, dichlobenil, dichloralurea, dichlormate, dichlorprop, dichlorprop-2-ethylhexyl, dichlorprop-butotyl, dichlorprop-dimethylammonium, dichlorprop-ethylammonium, dichlorprop-isoctyl, dichlorprop-methyl, dichlorprop-P, dichlorprop-P-dimethylammonium, dichlorprop-potassium, dichlorprop-sodium, diclofop, diclofop-methyl, diclosulam, diethamquat, diethamquat dichloride, diethatyl, diethatyl-ethyl, difenopenten, difenopenten-ethyl, difenoxuron, difenzoquat, difenzoquat metilsulfate, diflufenican, diflufenzopyr, diflufenzopyr-sodium, dimefuron, dimepiperate, dimethachlor, dimethametryn, dimethenamid, dimethenamid-P, dimexano, dimidazon, dinitramine, dinofenate, dinoprop, dinosam, dinoseb, dinoseb acetate, dinoseb-ammonium, dinoseb-diolamine, dinoseb-sodium, dinoseb-trolamine, dinoterb, dinoterb acetate, diphacinone-sodium, diphenamid, dipropetryn, diquat, diquat dibromide, disul, disul-sodium, dithiopyr, diuron, DMPA, DNOC, DNOC-ammonium, DNOC-potassium, DNOC-sodium, DSMA, EBEP, eglinazine, eglinazine-ethyl, endothal, endothal-diammonium, endothal-dipotassium, endothal-disodium, epronaz, EPTC, erbon, esprocarb, ethalfluralin, ethametsulfuron, ethametsulfuron-methyl, ethidimuron, ethiolate, ethofumesate, ethoxyfen, ethoxyfen-ethyl, ethoxysulfuron, etinofen, etnipromid, etobenzanid, EXD, fenasulam, fenoprop, fenoprop-3-butoxypropyl, fenoprop-butomethyl, fenoprop-butotyl, fenoprop-butyl, fenoprop-isoctyl, fenoprop-methyl, fenoprop-potassium, fenoxaprop, fenoxaprop-ethyl, fenoxaprop-P, fenoxaprop-P-ethyl, fenoxasulfone, fenteracol, fenthiaprop, fenthiaprop-ethyl, fentrazamide, fenuron, fenuron TCA, ferrous sulfate, flamprop, flamprop-isopropyl, flamprop-M, flamprop-methyl, flamprop-M-isopropyl, flamprop-M-methyl, flazasulfuron, florasulam, fluazifop, fluazifop-butyl, fluazifop-methyl, fluazifop-P, fluazifop-P-butyl, fluazolate, flucarbazone, flucarbazone-sodium, flucetosulfuron, fluchloralin, flufenacet, flufenican, flufenpyr, flufenpyr-ethyl, flumetsulam, flumezin, flumiclorac, flumiclorac-pentyl, flumioxazin, flumipropyn, fluometuron, fluorodifen, fluoroglycofen, fluoroglycofen-ethyl, fluoromidine, fluoronitrofen, fluothiuron, flupoxam, flupropacil, flupropanate, flupropanate-sodium, flupyrsulfuron, flupyrsulfuron-methyl-s odium, fluridone, fluorochloridone, fluoroxypyr, fluoroxypyr-butomethyl, fluoroxypyr-meptyl, flurtamone, fluthiacet, fluthiacet-methyl, fomesafen, fomesafen-sodium, foramsulfuron, fosamine, fosamine-ammonium, furyloxyfen, glufosinate, glufosinate-ammonium, glufosinate-P, glufosinate-P-ammonium, glufosinate-P-sodium, glyphosate, glyphosate-diammonium, glyphosate-dimethylammonium, glyphosate-isopropylammonium, glyphosate-monoammonium, glyphosate-potassium, glyphosate-sesquisodium, glyphosate-trimesium, halosafen, halosulfuron, halosulfuron-methyl, haloxydine, haloxyfop, haloxyfop-etotyl, haloxyfop-methyl, haloxyfop-P, haloxyfop-P-etotyl, haloxyfop-P-methyl, haloxyfop-sodium, hexachloroacetone, hexaflurate, hexazinone, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazaquin-methyl, imazaquin-sodium, imazethapyr, imazethapyr-ammonium, imazosulfuron, indanofan, indaziflam, iodobonil, iodomethane, iodosulfuron, iodosulfuron-methyl-sodium, ioxynil, ioxynil octanoate, ioxynil-lithium, ioxynil-sodium, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA, MCPA-2-ethylhexyl, MCPA-butotyl, MCPA-butyl, MCPA-dimethylammonium, MCPA-diolamine, MCPA-ethyl, MCPA-isobutyl, MCPA-isoctyl, MCPA-isopropyl, MCPA-methyl, MCPA-olamine, MCPA-potassium, MCPA-sodium, MCPA-thioethyl, MCPA-trolamine, MCPB, MCPB-ethyl, MCPB-methyl, MCPB-sodium, mecoprop, mecoprop-2-ethylhexyl, mecoprop-dimethylammonium, mecoprop-diolamine, mecoprop-ethadyl, mecoprop-isoctyl, mecoprop-methyl, mecoprop-P, mecoprop-P-dimethylammonium, mecoprop-P-isobutyl, mecoprop-potassium, mecoprop-P-potassium, mecoprop-sodium, mecoprop-trolamine, medinoterb, medinoterb acetate, mefenacet, mefluidide, mefluidide-diolamine, mefluidide-potassium, mesoprazine, mesosulfuron, mesosulfuron-methyl, mesotrione, metam, metam-ammonium, metamifop, metamitron, metam-potassium, metam-sodium, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metolachlor, metosulam, metoxuron, metribuzin, metsulfuron, metsulfuron-methyl, molinate, monalide, monisouron, monochloroacetic acid, monolinuron, monuron, monuron TCA, morfamquat, morfamquat dichloride, MSMA, naproanilide, napropamide, naptalam, naptalam-sodium, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxapyrazon-dimolamine, oxapyrazon-sodium, oxasulfuron, oxaziclomefone, oxyfluorfen, parafluoron, paraquat, paraquat dichloride, paraquat dimetilsulfate, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picloram-2-ethylhexyl, picloram-isoctyl, picloram-methyl, picloram-olamine, picloram-potassium, picloram-triethylammonium, picloram-tris(2-hydroxypropyl)ammonium, picolinafen, pinoxaden, piperophos, potassium arsenite, potassium azide, potassium cyanate, pretilachlor, primisulfuron, primisulfuron-methyl, procyazine, prodiamine, profluazol, profluralin, profoxydim, proglinazine, proglinazine-ethyl, prometon, prometryn, propachlor, propanil, propaquizafop, propazine, propham, propisochlor, propoxycarbazone, propoxycarbazone-sodium, propyrisulfuron, propyzamide, prosulfalin, prosulfocarb, prosulfuron, proxan, proxan-sodium, prynachlor, pydanon, pyraclonil, pyraflufen, pyraflufen-ethyl, pyrasulfotole, pyrazolynate, pyrazosulfuron, pyrazosulfuron-ethyl, pyrazoxyfen, pyribenzoxim, pyributicarb, pyriclor, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quinonamid, quizalofop, quizalofop-ethyl, quizalofop-P, quizalofop-P-ethyl, quizalofop-P-tefuryl, rhodethanil, rimsulfuron, saflufenacil, sebuthylazine, secbumeton, sethoxydim, siduron, simazine, simeton, simetryn, SMA, S-metolachlor, sodium arsenite, sodium azide, sodium chlorate, sulcotrione, sulfallate, sulfentrazone, sulfometuron, sulfometuron-methyl, sulfosulfuron, sulfuric acid, sulglycapin, swep, TCA, TCA-ammonium, TCA-calcium, TCA-ethadyl, TCA-magnesium, TCA-sodium, tebutam, tebuthiuron, tefuryltrione, tembotrione, tepraloxydim, terbacil, terbucarb, terbuchlor, terbumeton, terbuthylazine, terbutryn, tetrafluoron, thenylchlor, thiazafluoron, thiazopyr, thidiazimin, thidiazuron, thiencarbazone, thiencarbazone-methyl, thifensulfuron, thifensulfuron-methyl, thiobencarb, tiocarbazil, tioclorim, topramezone, tralkoxydim, tri-allate, triasulfuron, triaziflam, tribenuron, tribenuron-methyl, tricamba, triclopyr, triclopyr-butotyl, triclopyr-ethyl, triclopyr-triethylammonium, tridiphane, trietazine, trifloxysulfuron, trifloxysulfuron-s odium, trifluralin, triflusulfuron, triflusulfuron-methyl, trifop, trifop-methyl, trifopsime, trihydroxytriazine, trimeturon, tripropindan, tritac, tritosulfuron, vernolate, xylachlor, (collectively these commonly named herbicides are defined as the “Herbicide Group”).

### Biopesticides

Salicylic acid or agriculturally acceptable salts thereof may also be used in combination (such as in a compositional mixture, or a simultaneous or sequential application) with one or more biopesticides. The term “biopesticide” is used for microbial biological pest control agents that are applied in a similar manner to chemical pesticides. Commonly these are bacterial, but there are also examples of fungal control agents, including Trichoderma spp. and Ampelomyces quisqualis (a control agent for grape powdery mildew). Bacillus subtilis is used to control plant pathogens. Weeds and rodents have also been controlled with microbial agents. One well-known insecticide example is Bacillus thuringiensis, a bacterial disease of Lepidoptera, Coleoptera, and Diptera. Because it has little effect on other organisms, it is considered more environmentally friendly than synthetic pesticides. Biological insecticides include products based on:

1. entomopathogenic fungi (e.g. Metarhizium anisopliae);

2. entomopathogenic nematodes (e.g. Steinernema feltiae); and

3. entomopathogenic viruses (e.g. Cydia pomonella granulovirus).

Other examples of entomopathogenic organisms include, but are not limited to, baculoviruses, bacteria and other prokaryotic organisms, fungi, protozoa and Microsproridia. Biologically derived insecticides include, but not limited to, rotenone, veratridine, as well as microbial toxins; insect tolerant or resistant plant varieties; and organisms modified by recombinant DNA technology to either produce insecticides or to convey an insect resistant property to the genetically modified organism. In one embodiment, salicylic acid or agriculturally acceptable salts thereof may be used with one or more biopesticides in the area of seed treatments and soil amendments. The Manual of Biocontrol Agents gives a review of the available biological insecticide (and other biology-based control) products. Copping L. G. (ed.) (2004). The Manual of Biocontrol Agents (formerly the Biopesticide Manual) 3rd Edition. British Crop Production Council (BCPC), Farnham, Surrey UK.

### Other Active Compounds

Salicylic acid or agriculturally acceptable salts thereof may also be used in combination (such as in a compositional mixture, or a simultaneous or sequential application) with one or more of the following:
1. 3-(4-chloro-2,6-dimethylphenyl)-4-hydroxy-8-oxa-1-azaspiro[4,5]dec-3-en-2-one;
2. 3-(4′-chloro-2,4-dimethyl[1,1′-biphenyl]-3-yl)-4-hydroxy-8-oxa-1-azaspiro[4,5]dec-3-en-2-one;
3. 4-[[(6-chloro-3-pyridinyl)methyl]methylamino]-2(5H)-furanone;
4. 4-[[(6-chloro-3-pyridinyl)methyl]cyclopropylamino]-2(5H)-furanone;
5. 3-chloro-N2-[(1S)-1-methyl-2-(methylsulfonyl)ethyl]-N1-[2-methyl-4-[1,2,2-,2-tetrafluoro-1-(trifluoromethyl)ethyl]phenyl]-1,2-benzenedicarboxamide;
6. 2-cyano-N-ethyl-4-fluoro-3-methoxy-benenesulfonamide;
7. 2-cyano-N-ethyl-3-methoxy-benzenesulfonamide;
8. 2-cyano-3-difluoromethoxy-N-ethyl-4-fluoro-benzenesulfonamide;
9. 2-cyano-3-fluoromethoxy-N-ethyl-benzenesulfonamide;
10. 2-cyano-6-fluoro-3-methoxy-N,N-dimethyl-benzenesulfonamide;
11. 2-cyano-N-ethyl-6-fluoro-3-methoxy-N-methyl-benzenesulfonamide;
12. 2-cyano-3-difluoromethoxy-N,N-dimethylbenzenesulfon-amide;
13. 3-(difluoromethyl)-N-[2-(3,3-dimethylbutyl)phenyl]-1-methyl-1H-pyrazole-4-carboxamide;
14. N-ethyl-2,2-dimethylpropionamide-2-(2,6-dichloro-α,α,α-trifluoro-p-tolyl)hydrazone;
15. N-ethyl-2,2-dichloro-1-methylcyclopropane-carboxamide-2-(2,6-dichloro-α,α,α-trifluoro-p-tolyl)hydrazone nicotine;
16. O-{(E-)-[2-(4-chloro-phenyl)-2-cyano-1-(2-trifluoromethylphenyl)-vinyl]}S-methyl thiocarbonate;
17. (E)-N-1-[(2-chloro-1,3-thiazol-5-ylmethyl)]-N2-cyano-N-1-methylacetamidin-e;
18. 1-(6-chloropyridin-3-ylmethyl)-7-methyl-8-nitro-1,2,3,5,6,7-hexahydro-imidazo[1,2-a]pyridin-5-ol;
19. 4-[4-chlorophenyl-(2-butylidine-hydrazono)methyl)]phenyl mesylate; and
20. N-Ethyl-2,2-dichloro-1-methylcyclopropanecarboxamide-2-(2,6-dichloro-α,α,α-trifluoro-p-tolyl)hydrazone.

Salicylic acid or agriculturally acceptable salts thereof may also be used in combination (such as in a compositional mixture, or a simultaneous or sequential application) with one or more compounds in the following groups: algicides, antifeedants, avicides, bactericides, bird repellents, chemosterilants, herbicide safeners, insect attractants, insect repellents, mammal repellents, mating disrupters, molluscicides, plant activators, plant growth regulators, rodenticides, and/or virucides (collectively these commonly named groups are defined as the “AI Group”). It should be noted that compounds falling within the AI Group, Insecticide Group, Fungicide Group, Herbicide Group, Acaricide Group, or Nematicide Group might be in more than one group, because of multiple activities the compound has. For more information consult the “COMPENDIUM OF PESTICIDE COMMON NAMES” located at Worldwide Website: alanwood.net/pesticides/index.html. Also consult “THE PESTICIDE MANUAL” 14th Edition, edited by C D S Tomlin, copyright 2006 by British Crop Production Council, or its prior or more recent editions.

### Fertilizers

Salicylic acid compounds or agriculturally acceptable salts thereof of the present invention may also be applied with fertilizers. Fertilizer is often applied as a formulated (N-P-K) solid, granule or powder, or sometimes as a liquid, to an area to be fertilized. There are basically two types of fertilizers, water-soluble fertilizers and “slow-release” fertilizers. Such fertilizers can include urea-formaldehyde (UF) condensation products are widely used as slow-release nitrogen fertilizers for crops, ornamental plants and grasses. Urea-formaldehyde fertilizer materials also can be supplied either as liquids or as solids and are the reaction products of urea and formaldehyde. Such materials generally contain at least 28% nitrogen, largely in a water-insoluble, slowly available form.

Additionally, extended release UF fertilizers (ureaform) can be utilized and prepared by reacting urea and formaldehyde at an elevated temperature in an alkaline solution to produce methylol ureas. The methylol ureas then are acidified to polymerize the methylol ureas to methylene ureas, which increase in chain length as the reaction is allowed to continue. These methylene urea polymers normally have limited water solubility, and, thus, release nitrogen throughout an extended period. Such UF fertilizers usually include a mixture of methylene urea polymers generally have a range of molecular weights and are understood to be degraded slowly by microbial action into water-soluble nitrogen. UF fertilizers are usually categorized by the amount and the release characteristics of their water insoluble nitrogen.

U.S. Pat. No. 4,089,899 (the disclosure of which is incorporated herein by reference) describes a solid, controlled release nitrogen fertilizer of the ureaform type, which consists essentially of only two nitrogen fractions: water-soluble nitrogen and cold water insoluble nitrogen. U.S. Pat. No. 3,677,736 (the disclosure of which is incorporated herein by reference) describes a urea-formaldehyde fertilizer suspension. Other disclosures of urea-formaldehyde fertilizer compositions, both liquid and solid forms, include U.S. Pat. Nos. 4,378,238; 4,554,005; 5,039,328; 5,266,097; 5,674,971; 6,432.156; 6,464,746; 6,900,162; 6,936,573 and 6,936.681, the disclosure of which are all incorporated herein by reference.

Additionally, granular fertilizer can be applied in a combination with the salicylic acid compounds of the present invention. Granular nitrogen-containing fertilizers have been produced commercially by a variety of techniques using water-soluble nitrogen products, such as urea, potassium nitrate, and ammonium phosphate. The practical advantages of handling, blending, and storing such fertilizer granules are known and well documented. The preparation of granular fertilizers using slow-release UF fertilizers also has been described in the prior art. Poly(aspartic acid) may also be used in combination to enhance plant nutrient uptake. See U.S. Pat. No. 5,593,947 (incorporated herein by reference). For example, U.S. Pat. No. 5,350,735 incorporated herein by reference) discloses ammoniacal nitrogen, nitrate nitrogen and urea nitrogen combined with poly(aspartic acid) to form a fertilizer.

The salicylic acid compounds or agriculturally acceptable salts thereof can also be combined in a composition to comprise further solid or liquid auxiliaries, such as stabilizers, for example unepoxidized or epoxidized vegetable oils (for example epoxidized coconut oil, rapeseed oil or soya oil), antifoams, for example silicone oil, preservatives, viscosity regulators, binders and/or tackifiers; fertilizers, in particular nitrogen containing fertilizers such as ammonium nitrates and urea as described in WO08/017,388, which can enhance the efficacy of the inventive compounds; or other active ingredients for achieving specific effects, for example ammonium or phosphonium salts, in particular halides, (hydrogen)sulphates, nitrates, (hydrogen)carbonates, citrates, tartrates, formiates and acetates, as described in WO07/068,427 and WO07/068,428, which also can enhance the efficacy of the inventive compounds and which can be used in combination with penetration enhancers such as alkoxalated fatty acids; bactericides, fungicides, nematocides, plant activators, molluscicides or herbicides.

In other embodiments of the present invention, an effective seed treatment can comprise a seed treated with a combination comprising the salicylic acid or agriculturally acceptable salt, and a Mn⁺² and/or Zn⁺² ion source.

Additional embodiments for an effective seed treatment can comprises a seed treated with a combination comprising the salicylic acid or agriculturally acceptable salt and second component comprising a plant growth hormone. The plant growth hormone can be from the class of abscisic acid, auxins, cytokinins, gibberellins, brassinolides, salicylic acid, jasmonates, plant peptides, polyamines, and stringolactones. In additional embodiments, methods of promoting healthy growth of plant seeds is provided that comprises applying to the seeds a coating or dressing of a polymer or other matrix, the polymer or matrix comprising the salicylic acid or agriculturally acceptable salt and optionally one or more pesticides and/or one or more natural plant hormones. The polymer or matrix is capable of releasing the salicylic acid or agriculturally acceptable salt and optionally one or more pesticides and/or one or more natural plant hormones (collectively, “the actives”). The polymer or matrix can be designed to release the actives in response to temperature, moisture content, sunlight, time, or combinations thereof. The polymer or matrix can quickly dissolve or disintegrate releasing the actives or can controllable release the actives over time or in response to a predetermined condition such as temperature, moisture content, sunlight, time, or combinations thereof. The polymer or matrix can be multi-layer, with discrete layers, for example, for disrupting the coating to allow moisture ingress, housing the actives, etc. Suitable polymers or matrixes include hydrogels, microgels, or sol-gels. Specific materials and methods of coatings seeds useful in this regard include such process and materials as used, for example, Intellicoat™ (Landec Inc., Indiana); ThermoSeed™ (Incotec, Netherlands) CelPril™ (Bayer CropScience); ApronMaxx™ (Syngenta; Mefenoxam (CAS Nos. 70630-17-0 and 69516-34-3) 1.10%; Fludioxonil (CAS No. 131341-86-1) 0.73%; Other Ingredients: 98.17%; Cruiser™ (Syngenta; Thiamethoxam (CAS No. 153719-23-4) 47.6%, Other Ingredients: 52.4% Total: 100.0%); and Nacret™ (Syngenta). The actives can be provided as nanoparticles and incorporated into the polymer or matrix, or directly adhered to the seed coat. The thickness of the polymer or matrix coating may be between from about 0.01 mils to about 10 mils in thickness. The coating can further provide protection for the seeds from mechanical and environmental damages.

For seed treatment or seed coatings as described above, the amount of the salicylic acid or agriculturally acceptable salt can be about 0.01 mg/kg seed weight to about 30 mg/kg seed weight. Alternatively, seed treatment or seed coatings comprising salicylic acid or agriculturally acceptable salts thereof (e.g., calcium salicylate or sodium salicylate) can be applied at rates from about 0.10 oz per 100 lb seed to about 2.00 oz per 100 lb seed. In some embodiments, about 0.25 oz to about 0.75 oz per 100 lb seed of calcium salicylate and from about 0.50 oz to about 1.50 oz per 100 lb seed of sodium salicylate can be used. After an initial application of the salicylic acid or agriculturally acceptable salt as a seed treatment, it may be advantageous to apply one or more subsequent soil and/or foliar applications of the salicylic acid or agriculturally acceptable salt, for example, after emergence. Application frequency can be, for example, a single application, or up to four applications per season. In certain situations, a single application will suffice. In other situations, the first and/or second and/or third and/or fourth application may precede, supersede, or correspond to a particular growth cycle of the plant, or a known life cycle or endemic habit of an insect, parasite, or undesirable plant species.

Although it is believed that the present method can be applied to a seed in any physiological state, it is preferred that the seed be in a sufficiently durable state that it incurs no damage during the treatment process. Typically, the seed would be a seed that had been harvested from the field; removed from the plant; and separated from any cob, stalk, outer husk, and surrounding pulp or other non-seed plant material. The seed would preferably also be biologically stable to the extent that the treatment would cause no biological damage to the seed. It is believed that the treatment can be applied to the seed at any time between harvest of the seed and sowing of the seed or during the sowing process (seed directed applications).

The seed treatment may generally occur to an unsown seed, and the term “unsown seed” is meant to include seed at any period between the harvest of the seed and the sowing of the seed in the ground for the purpose of germination and growth of the plant.

Treatment to an unsown seed is not meant to include those practices in which the pesticide is applied to the soil but would include any application practice that would target the seed during the planting process.

Preferably, the treatment occurs before sowing of the seed so that the sown seed has been pre-treated.

Embodiments of the present invention may be applied before or after infection of the plant propagation material by a fungi or any type of plant pathogen.

The embodiments may be applied to the plant propagation material together with adjuvants customary in formulation technology. The salicylic acid compounds are preferably applied to plant propagation material in the form of compositions, but also can be applied to the plant propagation material simultaneously or in succession, with further compounds. These “further compounds” can be for example fertilizers, micronutrient donors, other preparations that influence plant growth, plant growth regulators, herbicides, insecticides, fungicides, bactericides, insect growth regulators, nematicides or molluscicides or mixtures of several of these preparations, such as two fungicides or a fungicide and an insecticide, if desired together with adjuvants, such as carriers, surfactants or other application-promoting adjuvants customarily employed in the art of formulation.

In a preferred embodiment the invention provides a method of controlling phytopathogenic diseases on useful plants or plant propagation material thereof, which comprises applying to said plant propagation material a agriculturally effective amount of a plant propagation material protecting composition together with a suitable carrier therefor.

The techniques of seed treatment application are well known to those skilled in the art, and they may be used readily in the context of the present invention. The salicylic acid compounds or a an agriculturally acceptable salt or plant propagation material protecting compositions comprising salicylic acid compounds or a an agriculturally acceptable salt together with a suitable carrier therefor can be formulated and applied as a slurry, a solid seed coating, a soak, or as a dust on the surface of the seed. There also may be mentioned, e.g., film-coating or encapsulation. The coating processes are well known in the art, and employ, for seeds, the techniques of film-coating or encapsulation, or for the other multiplication products, the techniques of immersion. Needless to say, the method of application of the salicylic acid compounds or an agriculturally acceptable salt thereof or of compositions comprising salicylic acid compounds or an agriculturally acceptable salt thereof together with a suitable carrier therefor to the seed may be varied and the invention is intended to include any technique which is to be used.

A preferred method of applying salicylic acid compounds or an agriculturally acceptable salt thereof or plant propagation material protecting compositions comprising salicylic acid compounds or an agriculturally acceptable salt thereof together with a suitable carrier therefor consists in spraying or wetting the plant propagation material with a liquid preparation, or mixing the plant material with a solid preparation of the salicylic acid compounds or an agriculturally acceptable salt thereof or plant propagation material protecting compositions comprising salicylic acid compounds or an agriculturally acceptable salt thereof together with a suitable carrier therefor.

The salicylic acid compounds or an agriculturally acceptable salt thereof or plant propagation material protecting compositions comprising salicylic acid compounds or an agriculturally acceptable salt thereof together with a suitable carrier therefor may be formulated or mixed in the seed treater tank or combined on the seed by overcoating with other seed treating agents. The agents to be mixed with the salicylic acid compounds or an agriculturally acceptable salt thereof or plant propagation material protecting compositions comprising salicylic acid compounds or an agriculturally acceptable salt thereof together with a suitable carrier therefor may be for the control of pests, modification of growth, nutrition, or for the control of plant diseases.

The plant propagation material protecting compositions applied to plant propagation material according to the instant invention may be employed in any conventional form, for example in the form of a twin pack, a powder for dry seed treatment (DS), an emulsion for seed treatment (ES), a flowable concentrate for seed treatment (FS), a solution for seed treatment (LS), a water dispersible powder for seed treatment (WS), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP) or any technically feasible formulation in combination with agriculturally acceptable adjuvants.

Such plant propagation material protecting compositions may be produced in conventional manner, e.g. by mixing the active ingredients with appropriate formulation inerts (solid or liquid carriers and optionally other formulating ingredients such as surface-active compounds (surfactants), biocides, anti-freezers, stickers, thickeners and compounds that provide adjuvancy effects). Also conventional slow release formulations may be employed where long lasting efficacy is intended. Particularly formulations to be applied in spraying forms, such as water dispersible concentrates (e.g. EC, SC, DC, OD, SE, EW, EO and the like), wettable powders and granules, may contain surfactants such as wetting and dispersing agents and other compounds that provide adjuvancy effects, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

Such plant propagation material protecting compositions may comprise one or more further pesticides, for example a fungicide, acaricide, bactericide, insecticide, molluscicide, nematicide, rodenticide, two fungicides or a fungicide and an insecticide.

The term “carrier” according to the invention denotes a natural or synthetic, organic or inorganic material with which the salicylic acid compounds or an agriculturally acceptable salt thereof is combined in order to facilitate its application to the plant, to the seeds or to the soil. This carrier is hence generally inert, and it must be agriculturally acceptable, in particular to the plant being treated. The carrier may be solid (clays, natural or synthetic silicates, silica, resins, waxes, solid fertilizers, and the like) or liquid (water, alcohols, ketones, petroleum fractions, aromatic or paraffinic hydrocarbons, chlorinated hydrocarbons, liquefied gases, and the like).

Solid carriers which may be used, for example for dusts and dispersible powders, are calcite, talc, kaolin, montmorillonite or attapulgite, highly-disperse silica or absorptive polymers. Possible particulate, adsorptive carriers for granules are pumice, crushed brick, sepiolite or bentonite, montmorillonite-type clay, and possible nonabsorbent carrier materials are calcite or dolomite.

Suitable liquid carriers are: aromatic hydrocarbons, in particular the fractions C₈ to C₁₂, such as xylene mixtures or substituted naphthalenes, phthalic esters such as dibutyl or dioctyl phthalate, aliphatic hydrocarbons such as cyclohexane or paraffins, alcohols and glycols as well as their ethers and esters, such as ethylene glycol monomethyl ether, ketones such as cyclohexanone, strongly polar solvents such as N-methyl-2-pyrrolidone, dimethyl sulfoxide or dimethylformamide, and, if appropriate, epoxidized vegetable oils or soybean oil; or water.

Suitable surface-active compounds are non-ionic, cationic and/or anionic surfactants having good emulsifying, dispersing and wetting properties, depending on the nature of the active ingredients to be formulated (whether only salicylic acid compounds or an agriculturally acceptable salt thereof or salicylic acid compounds or an agriculturally acceptable salt thereof in combination with other active ingredients). Surfactants will also be understood as meaning mixtures of surface-active compounds.

The surfactants customarily employed in formulation technology are described, inter alia, in the following publications: “McCutcheon's Detergents and Emulsifiers Annual”, MC Publishing Corp., Glen Rock, N.J., 1988. M. and J. Ash, “Encyclopedia of Surfactants”, Vol. I-III, Chemical Publishing Co., New York, 1980-1981.

Among the suitable surfactants there may be mentioned, e.g., polyacrylic acid salts, lignosulphonic acid salts, phenolsulphonic or (mono- or di-alkyl)naphthalenesulphonic acid salts, laurylsulfate salts, polycondensates of ethylene oxide with lignosulphonic acid salts, polycondensates of ethylene oxide with fatty alcohols or with fatty acids or with fatty amines, substituted phenols (in particular alkylphenols or arylphenols such as mono- and di-(polyoxyalkylene alkylphenol) phosphates, polyoxyalkylene alkylphenol carboxylates or polyoxyalkylene alkylphenol sulfates), salts of sulphosuccinic acid esters, taurine derivatives (in particular alkyltaurides), polycondensates of ethylene oxide with phosphated tristyrylphenols and polycondensates of ethylene oxide with phosphoric esters of alcohols or phenols. The presence of at least one surfactant is often required because the active ingredients and/or the inert vehicles are not soluble in water and the carrier for the application is water.

Furthermore, particularly useful adjuvants which enhance application are natural or synthetic phospholipids from the series of the cephalins and lecithins, for example phosphatidylethanolamine, phosphatidylserine, phosphatidylglycerine or lysolecithin.

The plant propagation material protecting composition may also comprise at least one polymer from water-soluble and water-dispersible film-forming polymers that improve the adherence of at least the salicylic acid compounds or an agriculturally acceptable salt thereof to the treated plant propagation material, which polymer generally has an average molecular weight of at least 10,000 to about 100,000.

Typically a coloring agent, such as a dye or pigment, is included in the plant propagation material protecting composition, so that an observer can immediately determine that the plant propagation material is treated. Plant propagation material protecting compositions comprising a coloring agent are preferred embodiments of the plant propagation material protecting compositions according to the invention, as they improve user and consumer safety. The coloring agent is also useful to indicate to the user the degree of uniformity of the applied plant propagation material protecting composition.

Generally, the coloring agent tends to have a melting point above 30° C., and therefore, is suspended in the plant propagation material protecting composition of the present invention. The coloring agent can also be a soluble compound.

As examples of coloring agents may be mentioned pigment red 48-2 (CAS-7023-61-2), pigment blue 15 (CAS-147-14-8), pigment green 7 (CAS-1328-53-6), pigment violet 23 (CAS-6358-30-1), pigment red 53-1 (CAS-5160-02-1), pigment red 57-1 (CAS 5281-04-9), pigment red 112 (CAS 6535-46-2) or similar coloring agents.

The plant propagation material protecting compositions tend to comprise between 0.1 to 10% by mass of a coloring agent.

Whereas commercial products will preferably be formulated as concentrates (known as a pre-mix composition (or concentrate, formulated compound (or product)), the end user will normally employ diluted formulations, optionally also containing one or more other pesticide pre-mixes (known as a tank mix composition (or ready-to-apply, spray broth, or slurry)) for treatment of the propagation material, but can also be use appropriately formulated pre-mix compositions.

The tank-mix compositions are generally prepared by diluting with a solvent (for example, water) the one or more pre-mix compositions containing different pesticides, and optionally further auxiliaries. Generally, an aqueous tank-mix is preferred.

Accordingly, examples of plant propagation material compositions of inventions include tank-mix or slurry pesticidal compositions and pre-mix or pesticidal formulations.

In general, the formulations include from 0.01 to 90% by weight of active agent, from 0 to 20% agriculturally acceptable surfactant and 10 to 99.99% solid or liquid carries and adjuvant(s), the active agent consisting of at least the salicylic acid compounds or an agriculturally acceptable salt thereof and optionally other active agents, particularly microbiocides or conservatives or the like.

Concentrated forms of compositions (such as pre-mix or pesticidal formulations) generally contain in between about 2 and 80%, preferably between about 5 and 70% by weight of active agent.

Tank-mix or slurry forms of concentrated forms of compositions (diluted formulations) may for example contain from 0.01 to 20% by weight, preferably from 0.01 to 5% by weight of active agent.

The amount of the salicylic acid compounds or an agriculturally acceptable salt thereof used on the propagation material varies according type of propagation material (e.g., seed or tuber) and plant (for example, wheat seeds generally have less active ingredients adhered thereto than oil seed rape seeds based on equivalent weight of seeds), and is such that the effective agriculturally amount can be determined by biology trials.

When the salicylic acid compounds or an agriculturally acceptable salt thereof or plant propagation material protecting compositions comprising salicylic acid compounds or an agriculturally acceptable salt thereof together with a suitable carrier therefor are used for treating seed, rates of 0.1 to 5000 g of a salicylic acid compounds or an agriculturally acceptable salt thereof per 100 kg of seed, preferably from 1 to 1000 g per 100 kg of seed, most preferably from 1 to 100 g per 100 kg of seed are generally sufficient.

In a further aspect of the invention, the invention provides a plant propagation material protecting composition comprising a salicylic acid compounds or an agriculturally acceptable salt thereof, together with a suitable carrier therefor.

A further embodiment of this aspect of the invention is plant propagation material treated with a plant propagation material protecting composition comprising a salicylic acid compounds or an agriculturally acceptable salt thereof, together with a suitable carrier therefor, wherein said plant propagation material protecting composition comprises additionally a coloring agent.

The following examples are provided to further illustrate the present invention, and should not be construed as limiting thereof.

### EXAMPLES

### Example 1

Snap Bean seeds were treated with various sources of calcium. In the laboratory, these tests examined the effects of four sources of supplementary calcium (calcium formate, calcium lactate, calcium nitrate, and calcium salicylate) on seed germination and seedling growth when added to a common snap bean seed treatments.

A Root Calcium Analysis was prepared and the effects of treatments on the concentration of calcium in the outer cell layers of snap bean roots was determined with an Environmental Scanning Electron Microscope (ESEM) using energy-dispersive X-ray analysis (EDX). Treated seed were grown in solarized (pathogen-free) field soil in the laboratory. Roots of five-day-old seedlings were freed from the soil and prepared for EDX analysis. A total of 192 EDX analyses were conducted on snap root segments using an ESEM at the University of Memphis.

### Example 2

Field Research Test: Calcium supplements were evaluated in two field tests for their effects on seedling diseases, plant growth, and yield. Both field tests were conducted at the University of Tennessee's West Tennessee Research and Education Center (“WTREC”). One was planted in the spring and one in late summer. The test area had been planted annually to snap bean or soybean since 2002 and was naturally infested with several soil-borne plant pathogens (e.g. Pythium spp., Rhizoctonia solani, Macrophomina phaseolina, and Fusarium spp.).

Spring-planted 2013 snap bean field test: A split-plot design was used with two potash treatments as main plots (no potash and muriate of potash at 100 lb K₂O/acre). Subplots consisted of six seed treatments on snap beans and two in-furrow sprays of a calcium nitrate solution. Main plots were replicated six times and subplot treatments twelve times. A seed bed was prepared with a disc and a field harrow, granular urea broadcast over the test area at 40 lb N/acre, and the nitrogen fertilizer incorporated with another pass of the field harrow. A common herbicide was applied as a preemergence herbicide. The test was planted on April 23. The WTREC received 1.31 inches of rain during the night of April 23-24 and nighttime air temperatures fell to near freezing. Potash treatments were broadcast by hand over the six potash main plots on April 26. Over 3.0 inches of rain were received April 27-28, creating conditions favorable for the development of seedling diseases. A standard seed treatment, with and without sources of supplementary calcium, and the two in-furrow rates of liquid calcium nitrate were subsequently evaluated for their effects on seedling emergence, seedling vigor, disease incidence, plant growth, and yield. The test was mechanically harvested with a one-row snap bean harvester on June 19.

### Example 3

Summer-planted 2013 snap bean field test: The test was planted in the same area as the spring-planted test following a mid-summer fallow period. A split-plot design was again used with two potash treatment as main plots (no potash or muriate of potash at 100 lb K₂O/acre). Subplots consisted of six seed treatments on snap beans as subplots. Main plots were replicated six times and subplot treatments twelve times. Potash treatments were broadcast by hand over the six potash main plots on August 1 and incorporated with a disc. A standard herbicide was broadcast over the test area and incorporated with a field harrow. The test was planted August 2. The WTREC received 0.81 inches of rain August 4-7 and an additional 0.79 inches of rain was received August 9-13. These showers created conditions favorable for the development of seedling diseases. Treatment effects on seedling emergence, seedling vigor, disease incidence, plant growth, and yield were recorded. The test was mechanically harvested with a one-row snap bean harvester on September 26 and October 1 (three replications each day).

### Example 4

Laboratory Tests: Compared to the distilled water control, supplementing the standard seed treatment with calcium formate, calcium lactate, calcium nitrate, or calcium salicylate significantly decreased the length of the root radical of germinating seed two days after planting (Table 1).

Root Calcium Analysis: The four supplementary calcium seed treatments were evaluated for their effects on the levels of calcium, magnesium, potassium, and phosphorus in the outer cell layers of snap bean seedling roots. Supplementing the standard seed treatment with calcium lactate or calcium formate led to a notable (p=0.06) increase in the level of calcium (Table 2b).

Spring-planted 2013 snap bean field test: Tables 3 to 6 summarize the effects of potash application, the supplementary seed treatments, and the in-furrow applications of liquid calcium nitrate fertilizer on seedling emergence, plant stand, snap bean growth, and yield. Seedling emergence 15 days after planting (May 8) was greatest and healthy plant stands highest when the standard seed treatment was supplemented with calcium salicylate (Table 3 and Table 4). Stands of healthy plants were highest when the standard seed treatment was supplemented with calcium salicylate particularly in plots receiving muriate of potash (Table 4). Lowest stands were with the distilled water control (Table 4). The principal pathogens isolated from diseased seedlings during the course of the experiment were identified (tentatively) as Fusarium spp. (60%), Macrophomina phaseolina (17%), Sclerotinia sclerotiorum (6%), and Rhizoctonia solani (5%). The treatments had no observed significant effects on seedling vigor (Table 5), plant height (Table 5), or the onset of plant flowering (Table 6). Overall snap bean yield was highest when the standard seed treatment was supplemented with calcium salicylate and lowest with the distilled water control (Table 6).

Summer-planted 2013 snap bean field test: Tables 7 to 11 summarize the effects of potash application and the supplementary seed treatments on seedling emergence, plant stand, snap bean growth and yield, and stand losses due to seedling diseases during the second 2013 snap bean field test. Seedling emergence 5 and 7 days after planting was significantly delayed with the application of potash (Table 7). Seed treatments had no significant effect of seedling emergence. Supplementing the standard snap bean seed treatment with 1.0 oz of sodium salicylate increased the number of healthy plants per row two weeks after planting (August 16) while 0.5 oz of sodium salicylate increased the number of healthy plants per row five weeks after planting (Table 8). Potash application increased the number of plants lost to seedling diseases, generally by over 50% to over 150% (Table 9). The ashy stem blight pathogen, Macrophomina phaseolina (the “charcoal rot” causal agent in soybeans), was isolated from 96% of the diseased plants. Potash application decreased the number of healthy plants five weeks after planting by over 16%, decreased plant height by 5%, and decreased snap bean yield by over 54% (Table 10). The seed treatment supplements failed to significantly affect plant height or snap bean yield.

TABLE 1
Effects of seed treatments on early root radical growth of Bronco
snap beans in modified ragdolls, Laboratory Tests 2 & 3, 2013.

| | Percent | Snap bean | | Snap bean | Rate Radical |
|---|---|---|---|---|---|
| Seed treatment number | seed | Seed Radical | | Seed Radical | Growth |
| and description | germination | Length (mm) | | Length (mm) | (mm/day) |
| (rate/100 lb seed) | after 2 days ^{x} | after 2 days | | after 3 days | day 2 to day 3 |
| 1. Distilled water (control) 10.0 fl oz | 91 A | 16.3 | A | 36.5 A | 20.2 A |
| 2. Standard Treatment 2 (ApronMaxx RTA | 94 A | 14.1 | AB | 33.2 A | 19.2 A |
| 5.0 fl oz. + Cruiser 1.28 fl oz) ¹ | | | | | |
| 3. Treatment 2 + calcium formate 1.0 oz | 90 A | 12.4 | BC | 33.1 A | 20.7 A |
| 4. Treatment 2 + calcium lactate 1.0 oz | 87 A | 12.0 | BC | 31.0 A | 19.0 A |
| 5. Treatment 2 + calcium nitrate 0.25 oz | 87 A | 11.9 | BC | 30.0 A | 18.0 A |
| 6. Treatment 2 + calcium salicylate 0.50 oz | 82 A | 10.6 | C | 27.8 A | 17.2 A |

| | | | | |
|---|---|---|---|---|
| Probability > F | 0.27 | 0.0077 | 0.14 | 0.53 |

¹ This is a combination seed treatment (two fungicides + an insecticide) commonly used on snap beans.

Values are the Least Square Means from SAS 9.3 PROC GLIMMIX analyses by one or more independent observers of seedling growth of nine replications of the six seed treatments in the spring 2013 field test.

Means in the same column followed by the same letter are not significantly different (p=0.05)^{x}.

^{x}CITATION: Saxton, A. M. 1998. A macro for converting mean separation output to letter groupings in Proc Mixed. In Proc. 23rd SAS Users Group Intl., SAS Institute, Cary, N.C., pp1243-1246. Nashville, Tenn., March 22-25.

Some treatment Notes: Most of the calcium-containing seed treatment supplements are actually hydrated. Their actual forms are calcium salicylate dihyrate (mol. wt. 350.34) [formula: Ca(C₇H₅O₃)₂.2H₂O, 11.44% Ca]; calcium lactate pentahydrate (mol. wt. 308.30) [formula: Ca(C₃H₅O₃)₂.5H₂O, 13.00% Ca]; and calcium nitrate tetrahydrate (mol. wt. 236.15) [formula: Ca(NO₃)₂.4H₂O, 16.97% Ca]. The calcium formate was not hydrated (mol. wt. 130.12) [formula: Ca(CHO₂)₂; 30.80% Ca].

TABLE 2a
Results of energy-dispersive X-ray (EDX) analyses of the effect of seed treatments
on the levels of calcium, magnesium, potassium, and phosphorus in roots of five-
day-old seedlings of snap beans grown in solarized soil - untransformed data.

| Seed Treatment | EDX Results - Net Intensity (counts/second) | | | | | | |
|---|---|---|---|---|---|---|---|
| (rate/100 lb seed) | calcium | | magnesium | potassium | | phosphorus | |
| 1. Distilled water (control) 10.0 fl oz | 41.8 | A ^{x} | 21.8 A | 225 | AB | 38.1 | AB |
| 2. Treatment 2 (ApronMaxx RTA 5.0 fl oz. + | 42.6 | A | 21.7 A | 227 | AB | 32.2 | B |
| Cruiser 1.28 fl oz) ¹ | | | | | | | |
| 3. Treatment 2 + calcium formate 1.0 oz | 49.6 | A | 25.5 A | 268 | A | 35.7 | AB |
| 4. Treatment 2 + calcium lactate 1.0 oz | 51.7 | A | 19.0 A | 183 | B | 29.5 | B |
| 5. Treatment 2 + calcium nitrate 0.25 oz | 42.4 | A | 19.9 A | 223 | AB | 44.8 | A |
| 6. Treatment 2 + calcium salicylate 0.50 oz | 49.5 | A | 24.0 A | 203 | B | 33.1 | B |

| | | | | |
|---|---|---|---|---|
| Probability > F | 0.38 | 0.26 | 0.03 | 0.09 |

¹ This is a combination seed treatment (two fungicides + an insecticide) commonly used on snap beans.

Values are the Least Square Means from SAS 9.3 PROC GLIMMIX analyses of four replications with two plants per seed treatment per replication, two root segments per plant, and two spot analyses per root segment=192 spot analyses.

Means in the same column followed by the same letter are not significantly different (p=0.10)^{x}.

TABLE 2b
Results of energy-dispersive X-ray (EDX) analyses of the effect of seed treatments
on the levels of calcium, magnesium, potassium, and phosphorus in roots of five-day-old
seedlings of snap beans grown in solarized soil - log₁₀ transformed data.

| Seed Treatment | EDX Results - Net Intensity (counts/second) | | | | | |
|---|---|---|---|---|---|---|
| (rate/100 lb seed) | calcium | | magnesium | potassium | phosphorus | |
| 1. Distilled water (control) 10.0 fl oz | 1.545 | ABC ^{x} | 1.281 A | 2.293 A | 1.492 | AB |
| 2. Treatment 2 (ApronMaxx RTA 5.0 fl oz. + | 1.511 | C | 1.253 A | 2.306 A | 1.394 | AB |
| Cruiser 1.28 fl oz) ¹ | | | | | | |
| 3. Treatment 2 + calcium formate 1.0 oz | 1.634 | AB | 1.352 A | 2.310 A | 1.512 | A |
| 4. Treatment 2 + calcium lactate 1.0 oz | 1.656 | A | 1.168 A | 2.242 A | 1.367 | B |
| 5. Treatment 2 + calcium nitrate 0.25 oz | 1.540 | BC | 1.221 A | 2.301 A | 1.512 | A |
| 6. Treatment 2 + calcium salicylate 0.50 oz | 1.624 | ABC | 1.278 A | 2.248 A | 1.383 | AB |

| | | | | |
|---|---|---|---|---|
| Probability > F | 0.06 | 0.14 | 0.45 | 0.08 |

¹ This is a combination seed treatment (two fungicides + an insecticide) commonly used on snap beans.

Values are the Least Square Means from SAS 9.3 PROC GLIMMIX analyses of four replications with two plants per seed treatment per replication, two root segments per plant, and two spot analyses per root segment=192 spot analyses.

Means in the same column followed by the same letter are not significantly different (p=0.10)^{x}.

^{x}CITATION: Saxton, A. M. 1998. A macro for converting mean separation output to letter groupings in Proc Mixed. In Proc. 23rd SAS Users Group Intl., SAS Institute, Cary, N.C., pp. 1243-1246. Nashville, Tenn., March 22-25.

TABLE 3
Effects of potash application, seed treatments, and in-furrow sprays
of a calcium nitrate solution on snap bean seedling emergence.¹

| Seed & In-furrow Treatments | Potash | Emergence (%) | | |
|---|---|---|---|---|
| (rate product/100 lb seed) | treatment³ | 6 May | | 8 May |
| 1. Distilled water (control) 10.0 fl oz | none | 6.9 | A ^{x} | 22.1 A |
| 2. Treatment 2 (ApronMaxx RTA 5.0 fl oz. + | none | 6.8 | A | 25.8 A |
| Cruiser 1.28 fl oz) ² | | | | |
| 3. Treatment 2 + calcium formate 1.0 oz | none | 8.7 | A | 34.3 A |
| 4. Treatment 2 + calcium lactate 1.0 oz | none | 11.7 | A | 35.8 A |
| 5. Treatment 2 + calcium nitrate 0.25 oz | none | 9.4 | A | 32.6 A |
| 6. Treatment 2 + calcium salicylate 0.50 oz | none | 10.2 | A | 40.0 A |
| 7. Treatment 2 + liquid calcium nitrate 3 lb | none | 7.1 | A | 29.1 A |
| N/acre, IF ⁴ | | | | |
| 8. Treatment 2 + liquid calcium nitrate 6 lb | none | 7.2 | A | 27.9 A |
| N/acre, IF ⁴ | | | | |
| 9. Distilled water (control) 10.0 fl oz | 0-0-60 | 4.9 | A | 20.1 A |
| 10. Treatment 2(ApronMaxx RTA 5.0 fl oz. + | 0-0-60 | 9.4 | A | 31.6 A |
| Cruiser 1.28 fl oz) ² | | | | |
| 11. Treatment 2 + calcium formate 1.0 oz | 0-0-60 | 8.4 | A | 29.4 A |
| 12. Treatment 2 + calcium lactate 1.0 oz | 0-0-60 | 7.8 | A | 26.3 A |
| 13. Treatment 2 + calcium nitrate 0.25 oz | 0-0-60 | 6.7 | A | 27.9 A |
| 14. Treatment 2 + calcium salicylate 0.50 oz | 0-0-60 | 13.2 | A | 39.4 A |
| 15. Treatment 2 + liquid calcium nitrate 3 lb | 0-0-60 | 6.5 | A | 30.6 A |
| N/acre, IF³ | | | | |
| 16. Treatment 2 + liquid calcium nitrate 6 lb | 0-0-60 | 8.0 | A | 31.3 A |
| N/acre, IF³ | | | | |

| | | |
|---|---|---|
| Probability > F | 0.35 | 0.06 |

| | Emergence (%) | |
|---|---|---|
| | 6 May | 8 May |
| Seed Treatment Mean | | |
| (with and without potash) | | |
| 1. Distilled water (control) 10.0 fl oz | 5.8 A | 21.1 C |
| 2. Treatment 2 (ApronMaxx RTA 5.0 fl oz. + | 8.2 A | 29.1 B |
| Cruiser 1.28 fl oz) ² | | |
| 3. Treatment 2 + calcium formate 1.0 oz | 8.7 A | 31.6 B |
| 4. Treatment 2 + calcium lactate 1.0 oz | 9.9 A | 31.3 B |
| 5. Treatment 2 + calcium nitrate 0.25 oz | 7.8 A | 29.8 B |
| 6. Treatment 2 + calcium salicylate 0.50 oz | 11.7 A | 40.1 A |
| 7. Treatment 2 + liquid calcium nitrate 3 lb | 6.8 A | 29.8 B |
| N/acre, IF ⁴ | | |
| 8. Treatment 2 + liquid calcium nitrate 6 lb | 7.5 A | 29.3 B |
| N/acre, IF ⁴ | | |
| Probability > F | 0.09 | 0.006 |
| Potash Treatment | | |
| A. none | 8.5 A | 31.1 A |
| B. 0-0-60 (muriate of potash) | 8.1 A | 29.5 A |
| Probability > F | 0.67 | 0.42 |

¹Values are the least square means. Means in the same column followed by the same letter are not significantly different (p = 0.05) based on SAS Proc GLIMMIX analyses of arcsin transformed data.
² This is a combination seed treatment (two fungicides + an insecticide) commonly used on snap beans.
³0-0-60 = muriate of potash [potassium chloride (KCl)] at 100 lb K₂O/A.
⁴ IF = in-furrow.

TABLE 4
Effects of potash application, seed treatments, and in-furrow
sprays of a calcium nitrate solution on snap bean stand.¹

| Seed & In-furrow Treatments | Potash | Plant stand (%) | | | |
|---|---|---|---|---|---|
| (rate product/100 lb seed) | Treatment⁴ | 28 May | | 4 June | |
| 1. Distilled water (control) 10.0 fl oz | none | 29.4 | D ^{x} | 31.2 | E |
| 2. Treatment 2 (ApronMaxx RTA 5.0 fl oz. + | none | 37.3 | CD | 36.0 | CDE |
| Cruiser 1.28 fl oz) ² | | | | | |
| 3. Treatment 2 + calcium formate 1.0 oz | none | 50.8 | B | 46.9 | ABC |
| 4. Treatment 2 + calcium lactate 1.0 oz | none | 53.6 | AB | 48.3 | AB |
| 5. Treatment 2 + calcium nitrate 0.25 oz | none | 48.3 | BC | 50.4 | AB |
| 6. Treatment 2 + calcium salicylate 0.50 oz | none | 54.3 | AB | 52.0 | AB |
| 7. Treatment 2 + liquid calcium nitrate 3 lb | none | 43.2 | BC | 44.3 | BCD |
| N/acre, IF⁴ | | | | | |
| 8. Treatment 2 + liquid calcium nitrate 6 lb | none | 42.1 | BC | 41.9 | BCDE |
| N/acre, IF | | | | | |
| 9. Distilled water (control) 10.0 fl oz | 0-0-60 | 29.8 | D | 33.5 | DE |
| 10. Treatment 2 (ApronMaxx RTA 5.0 fl oz. + | 0-0-60 | 45.9 | BC | 45.2 | BC |
| Cruiser 1.28 fl oz)² | | | | | |
| 11. Treatment 2 + calcium formate 1.0 oz | 0-0-60 | 45.1 | BC | 44.1 | BCD |
| 12. Treatment 2 + calcium lactate 1.0 oz | 0-0-60 | 45.4 | BC | 44.3 | BCD |
| 13. Treatment 2 + calcium nitrate 0.25 oz | 0-0-60 | 47.1 | BC | 45.4 | BCD |
| 14. Treatment 2 + calcium salicylate 0.50 oz | 0-0-60 | 63.1 | A | 59.0 | A |
| 15. Treatment 2 + liquid calcium nitrate 3 lb | 0-0-60 | 45.5 | BC | 46.5 | BC |
| N/acre, IF | | | | | |
| 16. Treatment 2 + liquid calcium nitrate 6 lb | 0-0-60 | 46.3 | BC | 40.7 | BCDE |
| N/acre, IF | | | | | |

| | | |
|---|---|---|
| Probability > F | <0.0001 | 0.003 |

| | Plant stand (%) | |
|---|---|---|
| | 28 May | 4 June |
| Seed Treatment Mean | | |
| (with and without potash) | | |
| 1. Distilled water (control) 10.0 fl oz | 29.4 C | 31.9 C |
| 2. Treatment 2 (ApronMaxx RTA 5.0 fl oz. + | 41.8 B | 40.5 B |
| Cruiser 1.28 fl oz) ² | | |
| 3. Treatment 2 + calcium formate 1.0 oz | 48.1 B | 46.0 B |
| 4. Treatment 2 + calcium lactate 1.0 oz | 49.6 B | 46.6 B |
| 5. Treatment 2 + calcium nitrate 0.25 oz | 47.0 B | 47.3 AB |
| 6. Treatment 2 + calcium salicylate 0.50 oz | 59.0 A | 55.6 A |
| 7. Treatment 2 + liquid calcium nitrate 3 lb | 44.4 B | 45.6 B |
| N/acre, IF | | |
| 8. Treatment 2 + liquid calcium nitrate 6 lb | 44.1 B | 41.0 B |
| N/acre, IF | | |
| Probability > F | <0.0001 | 0.0001 |
| Potash Treatment | | |
| A. none | 45.0 A | 44.7 A |
| B. 0-0-60 (muriate of potash) | 45.8 A | 44.0 A |
| Probability > F | 0.65 | 0.68 |

¹Values are the least square means. Means in the same column followed by the same letter are not significantly different (p = 0.05) based on SAS Proc GLIMMIX analyses of arcsin transformed data.
² This is a combination seed treatment (two fungicides + an insecticide) commonly used on snap beans.
³ 0-0-60 = muriate of potash [potassium chloride (KCl)] at 100 lb K₂O/A.
⁴IF = in-furrow.

TABLE 5
Effects of potash application, seed treatments, and in-furrow
sprays of a calcium nitrate solution on snap bean growth.¹

| | | Leaflet⁴ length | |
|---|---|---|---|
| Seed & In-furrow Treatments | Potash | (cm) | Plant height (cm) |
| (rate product/100 lb seed) | treatment² | 6 May | 10-11 June |
| 1. Distilled water (control) 10.0 fl oz | none | 2.2 A | 19.7 A |
| 2. Treatment 2 (ApronMaxx RTA 5.0 fl oz. + Cruiser 1.28 | none | 2.1 A | 18.0 A |
| fl oz)⁴ | | | |
| 3. Treatment 2 + calcium formate 1.0 oz | none | 2.3 A | 21.3 A |
| 4. Treatment 2 + calcium lactate 1.0 oz | none | 2.6 A | 21.4 A |
| 5. Treatment 2 + calcium nitrate 0.25 oz | none | 2.5 A | 21.0 A |
| 6. Treatment 2 + calcium salicylate 0.50 oz | none | 2.5 A | 20.3 A |
| 7. Treatment 2 + liquid calcium nitrate 3 lb N/acre, IF⁵ | none | 2.4 A | 19.4 A |
| 8. Treatment 2 + liquid calcium nitrate 6 lb N/acre, IF | none | 2.2 A | 19.9 A |
| 9. Distilled water (control) 10.0 fl oz | 0-0-60 | 2.1 A | 19.6 A |
| 10. Treatment 2 (ApronMaxx RTA 5.0 fl oz. + Cruiser | 0-0-60 | 2.5 A | 20.9 A |
| 1.28 fl oz) | | | |
| 11. Treatment 2 + calcium formate 1.0 oz | 0-0-60 | 2.5 A | 21.3 A |
| 12. Treatment 2 + calcium lactate 1.0 oz | 0-0-60 | 2.3 A | 19.5 A |
| 13. Treatment 2 + calcium nitrate 0.25 oz | 0-0-60 | 2.2 A | 20.0 A |
| 14. Treatment 2 + calcium salicylate 0.50 oz | 0-0-60 | 2.7 A | 22.8 A |
| 15. Treatment 2 + liquid calcium nitrate 3 lb N/acre, IF³ | 0-0-60 | 2.5 A | 20.8 A |
| 16. Treatment 2 + liquid calcium nitrate 6 lb N/acre, IF³ | 0-0-60 | 2.3 A | 20.0 A |

| | | |
|---|---|---|
| Probability > F | 0.61 | 0.62 |

| Seed Treatment Mean | Leaflet⁴ length (cm) | Plant height (cm) |
|---|---|---|
| (with and without potash) | 6 May | 10-11 June |
| 1. Distilled water (control) 10.0 fl oz | 2.2 A | 19.5 A |
| 2. Treatment 2 (ApronMaxx RTA 5.0 fl oz. + Cruiser 1.28 fl oz) | 2.3 A | 19.4 A |
| 3. Treatment 2 + calcium formate 1.0 oz | 2.4 A | 21.4 A |
| 4. Treatment 2 + calcium lactate 1.0 oz | 2.5 A | 20.5 A |
| 5. Treatment 2 + calcium nitrate 0.25 oz | 2.4 A | 20.3 A |
| 6. Treatment 2 + calcium salicylate 0.50 oz | 2.6 A | 21.6 A |
| 7. Treatment 2 + liquid calcium nitrate 3 lb N/acre, IF³ | 2.5 A | 20.1 A |
| 8. Treatment 2 + liquid calcium nitrate 6 lb N/acre, IF³ | 2.2 A | 19.9 A |
| Probability > F | 0.47 | 0.64 |

| | Leaflet⁴ length (cm) | Plant height (cm) |
|---|---|---|
| Potash Treatment | 6 May | 10-11 June |
| A. none | 2.4 A | 20.1 A |
| B. 0-0-60 (muriate of potash) | 2.4 A | 20.6 A |
| Probability > F | 0.62 | 0.41 |

¹Values are the least square means. Means in the same column followed by the same letter are not significantly different (p = 0.05) based on SAS Proc GLIMMIX analyses.
²0-0-60 = muriate of potash [potassium chloride (KCl)] at 100 lb K₂O/A.
³Length of the center leaflet of the first trifoliolate leaf (measures seedling vigor).
²This is a combination seed treatment (two fungicides + an insecticide) commonly used on snap beans.
⁵IF = in-furrow.

TABLE 6
Effects of potash application, seed treatments, and in-furrow sprays of
a calcium nitrate solution on plant flowering and snap bean yield.¹

| | | Percentage of plants | Snap bean yield⁴ |
|---|---|---|---|
| Seed & In-furrow Treatments | Potash | with open flowers | (lb/plot) |
| (rate product/100 lb seed) | treatment² | 3 June | 19 June |
| 1. Distilled water (control) 10.0 fl oz | none | 2.0 A | 1.15 A |
| 2. Treatment 2 (ApronMaxx RTA 5.0 fl oz. + Cruiser 1.28 fl | none | 5.7 A | 1.21 A |
| oz)⁴ | | | |
| 3. Treatment 2 + calcium formate 1.0 oz | none | 7.6 A | 2.04 A |
| 4. Treatment 2 + calcium lactate 1.0 oz | none | 14.6 A | 2.19 A |
| 5. Treatment 2 + calcium nitrate 0.25 oz | none | 4.6 A | 1.86 A |
| 6. Treatment 2 + calcium salicylate 0.50 oz | none | 4.1 A | 2.09 A |
| 7. Treatment 2 + liquid calcium nitrate 3 lb N/acre, IF⁵ | none | 7.2 A | 1.74 A |
| 8. Treatment 2 + liquid calcium nitrate 6 lb N/acre, IF | none | 3.3 A | 1.64 A |
| 9. Distilled water (control) 10.0 fl oz | 0-0-60 | 2.3 A | 1.01 A |
| 10. Treatment 2 (ApronMaxx RTA 5.0 fl oz. + Cruiser 1.28 fl | 0-0-60 | 3.0 A | 1.42 A |
| oz)⁴ | | | |
| 11. Treatment 2 + calcium formate 1.0 oz | 0-0-60 | 2.6 A | 1.66 A |
| 12. Treatment 2 + calcium lactate 1.0 oz | 0-0-60 | 6.1 A | 1.56 A |
| 13. Treatment 2 + calcium nitrate 0.25 oz | 0-0-60 | 10.3 A | 1.46 A |
| 14. Treatment 2 + calcium salicylate 0.50 oz | 0-0-60 | 5.1 A | 2.39 A |
| 15. Treatment 2 + liquid calcium nitrate 3 lb N/acre, IF | 0-0-60 | 2.8 A | 1.45 A |
| 16. Treatment 2 + liquid calcium nitrate 6 lb N/acre, IF | 0-0-60 | 8.6 A | 1.96 A |

| | | |
|---|---|---|
| Probability > F | 0.18 | 0.07 |

| | Percentage of plants | Snap bean yield⁴ | |
|---|---|---|---|
| Seed Treatment Mean | with open flowers | (lb/plot) | |
| (with and without potash) | 3 June | 19 June | |
| 1. Distilled water (control) 10.0 fl oz | 2.5 A | 1.08 | C |
| 2. Treatment 2 (ApronMaxx RTA 5.0 fl oz. + Cruiser 1.28 fl oz)⁴ | 4.8 A | 1.34 | BC |
| 3. Treatment 2 + calcium formate 1.0 oz | 4.7 A | 1.85 | AB |
| 4. Treatment 2 + calcium lactate 1.0 oz | 10.0 A | 1.90 | AB |
| 5. Treatment 2 + calcium nitrate 0.25 oz | 7.2 A | 1.61 | BC |
| 6. Treatment 2 + calcium salicylate 0.50 oz | 5.0 A | 2.25 | A |
| 7. Treatment 2 + liquid calcium nitrate 3 lb N/acre, IF | 4.8 A | 1.59 | BC |
| 8. Treatment 2 + liquid calcium nitrate 6 lb N/acre, IF | 6.2 A | 1.80 | AB |

| | | |
|---|---|---|
| Probability > F | 0.31 | 0.009 |

| | Percentage of plants | Snap bean yield⁴ |
|---|---|---|
| | with open flowers | (lb/plot) |
| Potash Treatment | 3 June | 19 June |
| A. none | 6.2 A | 1.75 A |
| B. 0-0-60 (muriate of potash) | 5.1 A | 1.60 A |
| Probability > F | 0.22 | 0.31 |

¹Values are the least square means. Means in the same column followed by the same letter are not significantly different (p = 0.05) based on SAS Proc GLIMMIX analyses of arcsin transformed data.
²0-0-60 = muriate of potash [potassium chloride (KCl)] at 100 lb K₂O/A.
³Plots were mechanically harvested with a one-row Pixall Model BH100 Bean Harvester on 19 June.
⁴This is a combination seed treatment (two fungicides + an insecticide) commonly used on snap beans.
⁵IF = in-furrow.

TABLE 7
Effects of potash application and seed treatments
on snap bean seedling emergence, late summer test.¹

| Seed Treatments | Potash | Emergence (%) | |
|---|---|---|---|
| (rate product/100 lb seed) | treatment² | 7 August | 9 August |
| 1. Distilled water (control) 10.0 fl oz | none | 24.3 A | 72.9 A |
| 2. Treatment 2 (ApronMaxx RTA 5.0 fl oz. + Cruiser 1.28 | none | 23.5 A | 72.0 A |
| fl oz) ³ | | | |
| 3. Treatment 2 + calcium salicylate 0.5 oz | none | 20.8 A | 72.5 A |
| 4. Treatment 2 + calcium salicylate 1.0 oz | none | 21.3 A | 73.4 A |
| 5. Treatment 2 + sodium salicylate 0.5 oz | none | 27.2 A | 78.1 A |
| 6. Treatment 2 + sodium salicylate 1.0 oz | none | 19.9 A | 74.2 A |
| 7. Distilled water (control) 10.0 fl oz | 0-0-60 | 18.1 A | 64.0 A |
| 8. Treatment 2 (ApronMaxx RTA 5.0 fl oz. + Cruiser 1.28 | 0-0-60 | 11.6 A | 65.7 A |
| fl oz) ³ | | | |
| 9. Treatment 2 + calcium salicylate 0.5 oz | 0-0-60 | 14.7 A | 68.9 A |
| 10. Treatment 2 + calcium salicylate 1.0 oz | 0-0-60 | 17.6 A | 70.7 A |
| 11. Treatment 2 + sodium salicylate 0.5 oz | 0-0-60 | 12.7 A | 68.8 A |
| 12. Treatment 2 + sodium salicylate 1.0 oz | 0-0-60 | 12.3 A | 70.1 A |

| | | |
|---|---|---|
| Probability > F | 0.23 | 0.53 |

| Seed Treatment Mean | Emergence (%) | |
|---|---|---|
| (with and without potash) | 7 August | 9 August |
| 1. Distilled water (control) 10.0 fl oz | 21.2 A | 68.5 A |
| 2. Treatment 2 (ApronMaxx RTA 5.0 fl oz. + Cruiser 1.28 fl oz) ³ | 17.5 A | 68.8 A |
| 3. Treatment 2 + calcium salicylate 0.5 oz | 17.7 A | 70.7 A |
| 4. Treatment 2 + calcium salicylate 1.0 oz | 19.5 A | 72.0 A |
| 5. Treatment 2 + sodium salicylate 0.5 oz | 20.0 A | 73.4 A |
| 6. Treatment 2 + sodium salicylate 1.0 oz | 16.1 A | 72.2 A |
| Probability > F | 0.18 | 0.19 |

Emergence (%)

| Potash Treatment² | 7 August | 9 August |
|---|---|---|
| A. none | 22.8 A | 73.9 A |
| B. 0-0-60 (muriate of potash) | 14.5 B | 68.0 B |
| Probability > F | <0.0001 | <0.0001 |

¹Values are the least square means. Means in the same column followed by the same letter are not significantly different (p = 0.05) based on SAS Proc GLIMMIX analyses of arcsin transformed data.
²0-0-60 = muriate of potash [potassium chloride (KCl)] at 100 lb K₂O/A.
³ This is a combination seed treatment (two fungicides + an insecticide) commonly used on snap beans.

TABLE 8
Effects of potash application and seed treatments on snap bean stand, late summer test ¹

| Seed Treatments | Potash | Healthy stand (%) | |
|---|---|---|---|
| (rate product/100 lb seed) | treatment² | 16 August | 5-6 September |
| 1. Distilled water (control) 10.0 fl oz | none | 74.1 A | 59.3 A |
| 2. Treatment 2 (ApronMaxx RTA 5.0 fl oz. + Cruiser 1.28 | none | 80.4 A | 62.1 A |
| fl oz) ³ | | | |
| 3. Treatment 2 + calcium salicylate 0.5 oz | none | 77.1 A | 67.8 A |
| 4. Treatment 2 + calcium salicylate 1.0 oz | none | 81.3 A | 67.2 A |
| 5. Treatment 2 + sodium salicylate 0.5 oz | none | 80.6 A | 69.8 A |
| 6. Treatment 2 + sodium salicylate 1.0 oz | none | 85.3 A | 66.7 A |
| 7. Distilled water (control) 10.0 fl oz | 0-0-60 | 65.7 A | 39.9 A |
| 8. Treatment 2 (ApronMaxx RTA 5.0 fl oz. + Cruiser 1.28 | 0-0-60 | 85.5 A | 54.3 A |
| fl oz) ³ | | | |
| 9. Treatment 2 + calcium salicylate 0.5 oz | 0-0-60 | 83.2 A | 60.1 A |
| 10. Treatment 2 + calcium salicylate 1.0 oz | 0-0-60 | 82.1 A | 58.0 A |
| 11. Treatment 2 + sodium salicylate 0.5 oz | 0-0-60 | 80.5 A | 60.1 A |
| 12. Treatment 2 + sodium salicylate 1.0 oz | 0-0-60 | 88.2 A | 57.7 A |

| | | |
|---|---|---|
| Probability > F | 0.13 | 0.62 |

| Seed Treatment Mean | Healthy stand (%) | | |
|---|---|---|---|
| (with and without potash) | 16 August | 5-6 September | |
| 1. Distilled water (control) 10.0 fl oz | 69.9 C | 49.6 | C |
| 2. Treatment 2 (ApronMaxx RTA 5.0 fl oz. + Cruiser 1.28 fl oz) ³ | 82.9 B | 58.2 | B |
| 3. Treatment 2 + calcium salicylate 0.5 oz | 80.2 B | 63.9 | AB |
| 4. Treatment 2 + calcium salicylate 1.0 oz | 81.7 B | 62.6 | AB |
| 5. Treatment 2 + sodium salicylate 0.5 oz | 80.5 B | 65.0 | A |
| 6. Treatment 2 + sodium salicylate 1.0 oz | 86.8 A | 62.2 | AB |

| | | |
|---|---|---|
| Probability > F | <0.0001 | <0.0001 |

Healthy stand (%)

| Potash Treatment² | 16 August | 5-6 September |
|---|---|---|
| A. none | 79.8 A | 65.5 A |
| B. 0-0-60 (muriate of potash) | 80.9 A | 55.0 B |
| Probability > F | 0.29 | 0.0001 |

¹ Values are the least square means. Means in the same column followed by the same letter are not significantly different (p = 0.05) based on SAS Proc GLIMMIX analyses of arcsin transformed data.
²0-0-60 = muriate of potash [potassium chloride (KCl)] at 100 lb K₂O/A.
³ This is a combination seed treatment (two fungicides + an insecticide) commonly used on snap beans.

TABLE 9a
Accumulative stand loss by fertilizer, seed treatment, and fertilizer × seed
treatment combinations, late summer snap bean test, 12 August to 23 August, 2013¹.

| | Julian Day | Julian Day | Julian Day | Julian Day | Julian Day |
|---|---|---|---|---|---|
| Treatment | 224 | 226 | 228 | 231 | 235 |

Fertilizer

| | | | | | |
|---|---|---|---|---|---|
| 0-0-60 | 0.5 A² | 1.3 A | 1.5 A | 1.7 A | 1.9 A |
| none | 0.3 A | 0.5 B | 0.7 B | 0.8 B | 0.8 B |

Seed Treatment

| | | | | | |
|---|---|---|---|---|---|
| 1. Distilled water (control) 10.0 fl oz | 2.7 A | 6.0 A | 7.2 A | 8.0 A | 8.6 A |
| 2. Treatment 2 (ApronMaxx RTA 5.0 fl oz. + | 0.1 B | 0.1 B | 0.1 B | 0.2 B | 0.2 B |
| Cruiser 1.28 fl oz)³ | | | | | |
| 3. Treatment 2 + calcium salicylate 0.5 oz | 0.0 B | 0.2 B | 0.3 B | 0.3 B | 0.4 B |
| 4. Treatment 2 + calcium salicylate 1.0 oz | 0.0 B | 0.0 B | 0.1 B | 0.2 B | 0.2 B |
| 5. Treatment 2 + sodium salicylate 0.5 oz | 0.0 B | 0.2 B | 0.2 B | 0.2 B | 0.3 B |
| 6. Treatment 2 + sodium salicylate 1.0 oz | 0.1 B | 0.2 B | 0.2 B | 0.2 B | 0.3 B |

Fertilizer × Seed treatment

| | | | | | | |
|---|---|---|---|---|---|---|
| 0-0-60 | Example 1 | 3.3 A | 8.3 A | 9.7 A | 10.8 A | 11.8 A |
| 0-0-60 | Example 2 | 0.2 C | 0.2 C | 0.2 C | 0.3 C | 0.3 C |
| 0-0-60 | Example 3 | 0.0 C | 0.4 C | 0.5 C | 0.6 C | 0.8 C |
| 0-0-60 | Example 4 | 0.0 C | 0.0 C | 0.1 C | 0.2 C | 0.2 C |
| 0-0-60 | Example 5 | 0.0 C | 0.3 C | 0.3 C | 0.3 C | 0.5 C |
| 0-0-60 | Example 6 | 0.2 C | 0.3 C | 0.3 C | 0.4 C | 0.5 C |
| none | Example 1 | 2.1 B | 3.7 B | 4.8 B | 5.1 B | 5.4 B |
| none | Example 2 | 0.0 C | 0.0 C | 0.1 C | 0.1 C | 0.2 C |
| none | Example 3 | 0.0 C | 0.0 C | 0.0 C | 0.0 C | 0.0 C |
| none | Example 4 | 0.0 C | 0.0 C | 0.2 C | 0.2 C | 0.3 C |
| none | Example 5 | 0.0 C | 0.1 C | 0.1 C | 0.1 C | 0.1 C |
| none | Example 6 | 0.0 C | 0.0 C | 0.0 C | 0.0 C | 0.0 C |

Probability >F

| | | | | | |
|---|---|---|---|---|---|
| Column: | 0.29 | 0.09 | 0.09 | 0.18 | 0.28 |
| Row: | 0.40 | 0.72 | 0.54 | 0.36 | 0.35 |
| Fertilizer: | 0.24 | 0.0004 | 0.001 | 0.0002 | 0.0001 |
| Seed treatment: | <0.0001 | <0.0001 | <0.0001 | <0.0001 | <0.0001 |
| Fertilizer × Seed: | 0.37 | <0.0001 | 0.0002 | <0.0001 | <0.0001 |

¹The test was planted on 2 Aug.
²Values are the least square means. Means in the same column followed by the same letter are not significantly (p = 0.05) different based on SAS Proc GLIMMIX analyses of arcsin transformed data and mean comparison tests of mean pairs.
³This is a combination seed treatment (two fungicides + an insecticide) commonly used on snap beans.

TABLE 9b
Accumulative stand loss by fertilizer, seed treatment, and fertilizer × seed
treatment combinations, late summer snap bean test, 29 August to 17 September, 2013¹.

| | Julian Day | Julian Day | Julian Day | Julian Day | Julian Day |
|---|---|---|---|---|---|
| Treatment | 241 | 246 | 249 | 253 | 260 |

Fertilizer

| | | | | | |
|---|---|---|---|---|---|
| 0-0-60 | 8.0 A² | 15.2 A | 19.3 A | 22.5 A | 25.3 A |
| none | 3.2 B | 8.9 B | 12.0 B | 14.1 B | 16.2 B |

Seed Treatment

| | | | | | |
|---|---|---|---|---|---|
| 1. Distilled water (control) 10.0 fl oz | 12.9 A | 19.2 A | 23.2 A | 26.2 A | 28.5 A |
| 2. Treatment 2 (ApronMaxx RTA 5.0 fl oz. + | 4.3 B | 12.9 B | 16.5 B | 18.7 B | 20.7 B |
| Cruiser 1.28 fl oz)³ | | | | | |
| 3. Treatment 2 + calcium salicylate 0.5 oz | 4.4 B | 10.3 B | 13.0 B | 15.2 B | 18.3 B |
| 4. Treatment 2 + calcium salicylate 1.0 oz | 3.6 B | 10.0 B | 13.1 B | 15.6 B | 18.0 B |
| 5. Treatment 2 + sodium salicylate 0.5 oz | 4.2 B | 8.7 B | 12.8 B | 16.1 B | 18.4 B |
| 6. Treatment 2 + sodium salicylate 1.0 oz | 4.2 B | 11.2 B | 15.3 B | 18.2 B | 20.7 B |

Fertilizer × Seed treatment

| | | | | | | |
|---|---|---|---|---|---|---|
| 0-0-60 | Example 1 | 18.6 A | 24.2 A | 28.4 A | 32.1 A | 34.2 A |
| 0-0-60 | Example 2 | 3.6 BC | 12.9 BC | 17.5 BC | 19.6 BC | 22.0 BCD |
| 0-0-60 | Example 3 | 6.2 B | 13.0 BC | 16.0 BC | 18.7 BC | 22.2 BCD |
| 0-0-60 | Example 4 | 6.6 B | 14.3 BC | 17.5 BC | 20.6 BC | 23.7 ABC |
| 0-0-60 | Example 5 | 5.6 BC | 11.3 BC | 16.3 BC | 20.8 BC | 23.5 ABC |
| 0-0-60 | Example 6 | 7.5 B | 15.4 B | 19.9 AB | 23.3 AB | 26.1 AB |
| none | Example 1 | 7.3 B | 14.2 BC | 18.0 BC | 20.2 BC | 22.8 BCD |
| none | Example 2 | 5.1 BC | 12.8 BC | 15.6 BC | 17.7 BC | 19.3 BCD |
| none | Example 3 | 2.7 BC | 7.6 BC | 10.0 C | 11.7 C | 14.5 BCD |
| none | Example 4 | 0.6 C | 5.8 C | 8.7 C | 10.5 C | 12.3 D |
| none | Example 5 | 2.7 BC | 6.1 C | 9.2 C | 11.4 C | 13.3 CD |
| none | Example 6 | 1.0 C | 7.0 BC | 10.8 BC | 13.1 BC | 15.3 BCD |

Probability >F

| | | | | | |
|---|---|---|---|---|---|
| Column: | 0.0001 | <0.0001 | <0.0001 | <0.0001 | <0.0001 |
| Row: | 0.005 | 0.0008 | 0.0007 | 0.0003 | 0.0002 |
| Fertilizer: | <0.0001 | 0.0002 | <0.0001 | <0.0001 | <0.0001 |
| Seed treatment: | <0.0001 | 0.04 | 0.03 | 0.06 | 0.10 |
| Fertilizer × Seed: | 0.07 | 0.78 | 0.89 | 0.87 | 0.91 |

¹The test was planted on 2 Aug.
²Values are the least square means. Means in the same column followed by the same letter are not significantly (p = 0.05) different based on SAS Proc GLIMMIX analyses of arcsin transformed data and mean comparison tests of mean pairs.
³This is a combination seed treatment (two fungicides + an insecticide) commonly used on snap beans.

TABLE 10
Effects of potash application and seed treatments
on snap bean growth and yield, late summer test ¹

| | | | Plot yield (lb) |
|---|---|---|---|
| Seed Treatments | Potash | Plant height (cm) | September 26- |
| (rate product/100 lb seed) | treatment² | 17 September | October 1 |
| 1. Distilled water (control) 10.0 fl oz | none | 20.9 A | 1.56 A |
| 2. Treatment 2 (ApronMaxx RTA 5.0 fl oz. + Cruiser | none | 19.9 A | 1.16 A |
| 1.28 fl oz) ³ | | | |
| 3. Treatment 2 + calcium salicylate 0.5 oz | none | 21.4 A | 2.52 A |
| 4. Treatment 2 + calcium salicylate 1.0 oz | none | 21.4 A | 1.91 A |
| 5. Treatment 2 + sodium salicylate 0.5 oz | none | 21.7 A | 1.76 A |
| 6. Treatment 2 + sodium salicylate 1.0 oz | none | 21.0 A | 1.85 A |
| 7. Distilled water (control) 10.0 fl oz | 0-0-60 | 18.7 A | 0.48 A |
| 8. Treatment 2 (ApronMaxx RTA 5.0 fl oz. + Cruiser | 0-0-60 | 21.5 A | 0.92 A |
| 1.28 fl oz) ³ | | | |
| 9. Treatment 2 + calcium salicylate 0.5 oz | 0-0-60 | 21.3 A | 1.02 A |
| 10. Treatment 2 + calcium salicylate 1.0 oz | 0-0-60 | 19.9 A | 0.74 A |
| 11. Treatment 2 + sodium salicylate 0.5 oz | 0-0-60 | 20.2 A | 0.86 A |
| 12. Treatment 2 + sodium salicylate 1.0 oz | 0-0-60 | 18.7 A | 0.85 A |

| Probability > F | 0.23 | 0.48 |
|---|---|---|
| | | Plot yield (lb) |
| Seed Treatment Mean | Plant height (cm) | September 26- |
| (with and without potash) | 17 September | October 1 |
| 1. Distilled water (control) 10.0 fl oz | 19.8 A | 1.02 A |
| 2. Treatment 2 (ApronMaxx RTA 5.0 fl oz. + Cruiser 1.28 fl oz) ³ | 20.7 A | 1.04 A |
| 3. Treatment 2 + calcium salicylate 0.5 oz | 21.4 A | 1.77 A |
| 4. Treatment 2 + calcium salicylate 1.0 oz | 20.7 A | 1.32 A |
| 5. Treatment 2 + sodium salicylate 0.5 oz | 20.9 A | 1.31 A |
| 6. Treatment 2 + sodium salicylate 1.0 oz | 19.9 A | 1.35 A |
| Probability > F | 0.38 | 0.17 |

| | | Plot yield (lb) |
|---|---|---|
| | Plant height (cm) | September 26- |
| Potash Treatment² | 17 September | October 1 |
| A. none | 21.1 A | 1.79 A |
| B. 0-0-60 (muriate of potash) | 20.1 B | 0.81 B |
| Probability > F | 0.03 | <0.0001 |

¹ Values are the least square means. Means in the same column followed by the same letter are not significantly different (p = 0.05) based on SAS Proc GLIMMIX analyses of arcsin transformed data.
²0-0-60 = muriate of potash [potassium chloride (KCl)] at 100 lb K₂O/A.
³ This is a combination seed treatment (two fungicides + an insecticide) commonly used on snap beans.

### Example 5

In another 2013 field experiment, four rates of an in-furrow calcium nitrate spray (0, 1, 2, and 3 kg N/ha) with and without muriate of potash were evaluated for their effects on soybean seedling diseases, seedling emergence, plant stand, plant growth, and yield of untreated soybean seed. Seedling emergence was more rapid in plots receiving muriate of potash than in unfertilized plots. Plants in plots receiving 1 kg N emerged more slowly than plants in plots receiving no nitrogen fertilization and had fewer healthy plants per row 26, 41, 74, and 109 days after planting.

### Example 6

Laboratory Tests: Initial tests examined the effects on seed germination and seedling growth of four sources of supplementary calcium (calcium formate, calcium lactate, calcium nitrate, and calcium salicylate) added to a common soybean seed treatment. Treated seed were then planted in solarized field soil (pathogen-free) to determine treatment effects on seedling growth. The potential effect of these seed treatments on seedling disease severity was determined by evaluating their effect on seedling root rot (or pruning) in greenhouse tests using field soil naturally infested with Rhizoctonia solani, Macrophomina phaseolina, Pythium spp. and Fusarium spp.

### Example 7

Root Calcium Analysis: The effects of treatments on the concentration of calcium in the outer cell layers of soybean roots was determined with an Environmental Scanning Electron Microscope (ESEM) using energy-dispersive X-ray analysis (EDX). Treated seed were grown in solarized soil in the laboratory. Seedling roots of 10- to 13-day old seedlings were freed from the soil and prepared for analysis. Using an ESEM at the University of Memphis, a total of 98 EDX analyses were conducted on soybean.

### Example 8

Field Research Test: Supplements found to improve seedling growth were evaluated in a field test for their effects on plant growth and crop yield. The field test was planted at the University of Tennessee's WTREC at Jackson, Tenn. The test area had been planted annually to soybean or snap bean since 2002 and was naturally infested with several soil-borne plant pathogens. The site was irrigated as needed to created conditions favorable for seedling disease development. The standard treatment with and without supplementary calcium and in-furrow applications of calcium nitrate at two rates were evaluated for their effects on seedling emergence, seedling vigor, disease incidence, plant growth, and yield.

### Example 9

Laboratory and Greenhouse Tests: Supplementing the standard seed treatment with 4% calcium lactate or with 4% calcium formate significantly increased the growth rate of the root radical of germinating seed compared to the seed treatment standard without supplement or to untreated seed in modified ragdoll tests (Table 11). Calcium supplemented seed treatments were next evaluated in solarized (pathogen-free) field soil for their effects on seedling emergence and growth. Best seedling growth (based on the length of the first trifoliolate leaves 10 days after planting) was observed when the standard seed treatment was supplemented with 4% calcium formate, 1% calcium nitrate, 4% calcium lactate, and 2% calcium salicylate (Table 12). These four seed treatment supplements were therefore chosen for field testing. A greenhouse test of in-furrow applications of granular calcium nitrate (15.5-0-0) at rates equivalent to 0, 4, and 8 lbs N/acre indicated that these two rates were very injurious to seed germination (data not shown). Two lower application rates of in-furrow granular calcium nitrate were therefore chosen for field testing. The effect of the four seed treatment supplements on seedling root rot was evaluated in pathogen-infested field soil in a series of greenhouse tests. No significant effects on seedling growth or root rot were observed in these tests (Table 13).

Root Calcium Analysis: The four supplementary calcium seed treatments were evaluated for their effects on the level of calcium and other nutrients in soybean seedling roots. Treated seed were grown in solarized soil in a series of laboratory experiments. Seedling roots of 10- to 13-day old seedlings were freed from the soil and prepared for analysis. Using an ESEM at the University of Memphis, a total of 98 EDX analyses were conducted. While the seed treatments had no effect on the level of many nutrients in seedling roots, the levels of calcium, magnesium, potassium, and phosphorus were significantly increased with the standard seed treatment compared to the untreated control (Table 14). Supplementing the standard seed treatment with calcium nitrate or calcium salicylate also significantly increased the level of potassium in seedling roots compared to the untreated control (Table 14). A follow-up test conducted in November indicated that it may be possible to increase the level of calcium in the roots of very young soybean seedlings with in-furrow applications of liquid calcium nitrate without a noticeable effect on seed germination.

Field Research Test: Tables 15 to 18 summarize the effects of the supplementary seed treatments and in-furrow applications of granular calcium nitrate fertilizer (15.5-0-0) on seedling emergence, plant stand, soybean growth, and yield in field plots fertilized with muriate of potash (0-0-60) or sulfate of potash (0-0-50) or without the addition of potash fertilizer. The overall effects of seed treatments, the in-furrow calcium nitrate treatments, and the three potash treatments are included in the tables. Seedling emergence six days after planting (14 June) was greatest with a standard seed treatment in unfertilized plots followed by the calcium salicylate supplemented seed treatment in plots fertilized with sulfate of potash (Table 15). Emergence was slowest with the in-furrow calcium nitrate treatments. Fertilization with muriate of potash also delayed seedling emergence compared to that observed in unfertilized plots. Stands of healthy plants were initially highest when a standard seed treatment was supplemented with calcium lactate in unfertilized plots but were highest in early August with the calcium salicylate supplement in plots receiving muriate of potash (Table 16). Lowest stands were with the in-furrow applications of granular calcium nitrate. The principal pathogens isolated from diseased seedlings were identified as Rhizoctonia solani, Macrophomina phaseolina, and Fusarium spp. Treatments had relatively few observable effects on plant growth. Seedling vigor (measured by the first trifoliolate leaflet length) was lowest with the in-furrow applications of granular calcium nitrate and in plots receiving applications of muriate of potash (Table 17). Tallest plants in mid-August were observed in with the calcium nitrate supplement in unfertilized plots. The highest yields (53 bu/A) were observed in plots receiving muriate of potash and the lower rate of in-furrow granular calcium nitrate (Table 18). Overall soybean yields were lowest with the higher rate of in-furrow granular calcium nitrate.

TABLE 11
Effects of soybean seed treatments on early root radical growth
in modified ragdolls, Laboratory Tests 2 & 3, 2012.

| | Soybean | | Soybean | | | |
|---|---|---|---|---|---|---|
| | Seed Radical | | Seed Radical | | Rate Radical | |
| | Growth | | Growth | | Growth | |
| | (mm) | | (mm) | | (mm/day) | |
| Seed treatment number and description | first 2 days | | first 3 days | | day 2 to day 3 | |
| 1) distilled water 10.0 fl oz | 0.4 | c | 4.9 | e | 4.5 | f |
| 2) Treatment 1 (Cruiser 1.28 fl oz) ¹ | 1.8 | bc | 10.7 | bcde | 9.0 | bcdef |
| 3) Treatment 3 (ApronMaxx RTA 5.0 fl oz. + Cruiser | 0.8 | bc | 6.0 | e | 5.2 | ef |
| 1.28 fl oz) ² | | | | | | |
| 4) Treatment 3 + 0.5% calcium formate | 0.9 | bc | 6.6 | de | 5.8 | def |
| 5) Treatment 3 + 1% calcium formate | 2.4 | ab | 12.5 | bcde | 10.1 | bcdef |
| 6) Treatment 3 + 2% calcium formate | 0.9 | bc | 7.4 | cde | 6.5 | def |
| 7) Treatment 3 + 4% calcium formate | 2.2 | abc | 16.8 | b | 14.6 | ab |
| 11) Treatment 3 + 4% calcium nitrate | 0.8 | bc | 12.2 | bcde | 11.4 | bcde |
| 12) Treatment 3 + 0.5% calcium lactate | 2.5 | ab | 14.4 | bc | 11.9 | bcd |
| 13) Treatment 3 + 1% calcium lactate | 1.7 | bc | 9.6 | bcde | 7.9 | cdef |
| 14) Treatment 3 + 2% calcium lactate | 1.0 | bc | 7.7 | cde | 6.8 | cdef |
| 15) Treatment 3 + 4% calcium lactate | 3.9 | a | 24.6 | a | 20.7 | a |
| 19) Treatment 3 + 4% calcium salicylate | 1.0 | bc | 14.0 | bcd | 13.1 | bc |

| | | | |
|---|---|---|---|
| F value | 2.13 | 4.02 | 4.22 |
| Probability > F | 0.0399 | 0.0006 | 0.0004 |
| LSD (P = 0.05) | 1.95 | 7.72 | 6.36 |

Values are the Least Square Means from SAS 9.3 PROC GLIMMIX analyses of the daily mean observation by three independent observers of seedling growth of two replications of fifteen seed treatments.
Means in the same column followed by the same letter are not significantly different (p = 0.05)^{x}.
¹ This is a common soybean seed treatment insecticide.
² This is a combination seed treatment (two fungicides + an insecticide) commonly used on soybeans.
^{x}CITATION: Saxton, A. M. 1998. A macro for converting mean separation output to letter groupings in Proc Mixed. In Proc. 23rd SAS Users Group Intl., SAS Institute, Cary, NC, pp. 1243-1246. Nashville, TN, March 22-25.

TABLE 12
Effects of seed treatments on soybean seedling emergence and early seedling
growth in solarized field soil, Greenhouse Test 2, planted 25 May 2012.

| | | | Unifoliolate | First | |
|---|---|---|---|---|---|
| | Seedling | | leaves | trifoliolates | |
| | Emergence (%) | | unfolding (%) | 1-2 cm long (%) | |
| Seed treatment description | 29 May | | 31 May | 4 June | |
| 1) distilled water 10.0 fl oz | 31.7 | abc | 55.8 a | 74.2 | bcde |
| 2) Treatment 2 (Cruiser 1.28 fl oz) ¹ | 40.0 | ab | 58.3 a | 90.0 | ab |
| 3) Treatment 3 (ApronMaxx RTA 5.0 fl oz. + Cruiser | 30.0 | bc | 51.7 a | 71.7 | cde |
| 1.28 fl oz) ² | | | | | |
| 4) Treatment 3 + 1% calcium formate | 27.5 | bcd | 38.3 a | 59.2 | ef |
| 5) Treatment 3 + 2% calcium formate | 50.0 | a | 67.5 a | 85.0 | abc |
| 6) Treatment 3 + 4% calcium formate | 38.3 | ab | 65.8 a | 92.5 | a |
| 7) Treatment 3 + 1% calcium nitrate | 40.8 | ab | 62.5 a | 84.2 | abc |
| 8) Treatment 3 + 2% calcium nitrate | 10.0 | de | 46.7 a | 75.8 | abcde |
| 9) Treatment 3 + 4% calcium nitrate | 27.5 | bcd | 49.2 a | 60.0 | ef |
| 10) Treatment 3 + 1% calcium lactate | 35.8 | ab | 55.0 a | 80.8 | abcd |
| 11) Treatment 3 + 2% calcium lactate | 7.5 | e | 33.3 a | 64.2 | def |
| 12) Treatment 3 + 4% calcium lactate | 34.2 | ab | 59.2 a | 90.8 | ab |
| 13) Treatment 3 + 1% calcium salicylate | 13.3 | cde | 31.2 a | 47.5 | f |
| 14) Treatment 3 + 2% calcium salicylate | 40.8 | ab | 65.8 a | 80.0 | abcd |
| 15) Treatment 3 + 4% calcium salicylate | 6.7 | e | 30.0 a | 65.0 | def |

| | | | |
|---|---|---|---|
| F value | 3.92 | 1.33 | 4.25 |
| Probability > F | <0.0001 | 0.2140 | <0.0001 |
| LSD (P = 0.05) | 19.3 | NS | 18.2 |

Values are the Least Square Means from SAS 9.3 PROC GLIMMIX analyses of the daily mean observation of seedling growth of two replications of the fifteen seed treatments by three independent observers.
Means in the same column followed by the same letter are not significantly different (p = 0.05).
¹ This is a common soybean seed treatment insecticide.
² This is a combination seed treatment (two fungicides + an insecticide) commonly used on soybeans.

TABLE 13
Effects of seed treatments on the relative root ranking
and root dry weight of soybean seedlings grown in pathogen-
infested field soil in the greenhouse.

| Seed Treatment | Root | Root dry |
|---|---|---|
| (rate/100 lb seed) | ranking* | weight (mg) |
| 1. distilled water (untreated control) | 4.6 a | 48 a |
| 3. Treatment 3 (ApronMaxx RTA 5.0 fl oz. + | 3.4 a | 43 a |
| Cruiser 1.28 fl oz) ¹ | | |
| 7. Treatment 3 + calcium formate 12.0 oz | 3.9 a | 43 a |
| 9. Treatment 3 + calcium nitrate 3.0 oz | 2.9 a | 44 a |
| 15. Treatment 3 + calcium lactate 12.0 oz | 2.7 a | 40 a |
| 18. Treatment 3 + calcium salicylate 6.0 oz | 3.4 a | 42 a |
| Probability > F | 0.07 | 0.45 |

Values are the Least Square Means from SAS 9.3 PROC GLIMMIX analyses of the four replications.
*Root ranking was on a 1 to 6 basis where 6 = the ‘best’ root systems (least root rot) and 1 = the ‘worst’ root systems (most root rot) based on the rankings of four independent observers.
¹ This is a combination seed treatment (two fungicides + an insecticide) commonly used on soybeans.

TABLE 14
Results of energy-dispersive X-ray (EDX) analyses on the effect of seed treatments on the levels of
calcium, magnesium, potassium, and phosphorus in seedling roots of soybeans grown in solarized soil.

| Seed Treatment | EDX | | | |
|---|---|---|---|---|
| (rate/100 lb seed) | calcium | magnesium | potassium | phosphorus |
| 1. distilled water (untreated control) | 77.2 b ¹ | 59.1 b | 108.6 b | 18.8 b |
| 3. Treatment 2 (ApronMaxx RTA 5.0 fl oz. + Cruiser | 95.1 a | 112.3 a | 172.1 a | 40.2 a |
| 1.28 fl oz) ² | | | | |
| 7. Treatment 2 + calcium formate 12.0 oz | 66.1 b | 62.8 b | 139.6 ab | 27.0 b |
| 9. Treatment 2 + calcium nitrate 3.0 oz | 72.6 b | 67.0 b | 110.5 a | 24.6 b |
| 15. Treatment 2 + calcium lactate 12.0 oz | 72.5 b | 46.0 b | 103.9 b | 23.2 b |
| 18. Treatment 2 + calcium salicylate 6.0 oz | 73.9 b | 57.0 b | 166.6 a | 23.6 b |
| Probability > F | 0.0364 | <0.0001 | 0.0131 | 0.0016 |

Values are the Least Square Means from SAS 9.3 PROC GLIMMIX analyses of the replications.
¹ Means in the same column followed by the same letter are not significantly different (p = 0.05)^{x}.
² This is a combination seed treatment (two fungicides + an insecticide) commonly used on soybeans.

TABLE 15
Effect of treatments (seed, in-furrow fertilizer, and potash form) on seedling emergence.*

| Seed & In-furrow Treatments | Potash | Emergence (%) | |
|---|---|---|---|
| (rate product/100 lb seed) | treatment** | 13 June | 14 June |

| | | | | | |
|---|---|---|---|---|---|
| 1. Treatment 1 (Cruiser 1.28 fl oz) ¹ | none | 32.9 | abcd | 52.5 | abcd |
| 2. Treatment 2 (ApronMaxx RTA 5.0 fl oz. + Cruiser 1.28 | none | 40.8 | a | 62.6 | a |
| fl oz) ² | | | | | |
| 3. Treatment 2 + calcium formate 12.0 oz | none | 28.6 | bcde | 47.0 | bcde |
| 4. Treatment 2 + calcium lactate 12.0 oz | none | 36.7 | ab | 54.0 | abc |
| 5. Treatment 2 + calcium nitrate 3.0 oz | none | 40.4 | a | 57.5 | ab |
| 6. Treatment 2 + calcium salicylate 6.0 oz | none | 28.3 | bcdef | 53.9 | abcd |
| 7. Treatment 2 + calcium nitrate 1 lb N/acre, IF*** | none | 24.5 | cdef | 40.4 | def |
| 8. Treatment 2 + calcium nitrate 2 lb N/acre, IF*** | none | 12.5 | ghi | 23.3 | hi |
| 9. Treatment 1 (Cruiser 1.28 fl oz) ¹ | 0-0-50 | 22.2 | defg | 44.0 | bcde |
| 10. Treatment 2 (ApronMaxx RTA 5.0 fl oz. + Cruiser 1.28 | 0-0-50 | 22.0 | bcdef | 47.6 | abcde |
| fl oz) ² | | | | | |
| 11. Treatment 2 + calcium formate 12.0 oz | 0-0-50 | 29.4 | bcde | 48.3 | bcde |
| 12. Treatment 2 + calcium lactate 12.0 oz | 0-0-50 | 32.2 | abcd | 49.1 | abcde |
| 13. Treatment 2 + calcium nitrate 3.0 oz | 0-0-50 | 26.4 | bcde | 49.0 | abcde |
| 14. Treatment 2 + calcium salicylate 6.0 oz | 0-0-50 | 35.1 | abc | 58.4 | ab |
| 15. Treatment 2 + calcium nitrate 1 lb N/acre, IF*** | 0-0-50 | 15.2 | fghi | 34.4 | efgh |
| 16. Treatment 2 + calcium nitrate 2 lb N/acre, IF*** | 0-0-50 | 7.7 | i | 20.9 | i |
| 17. Treatment 1 (Cruiser 1.28 fl oz) ¹ | 0-0-60 | 27.9 | abcde | 50.0 | abcde |
| 18. Treatment 2 (ApronMaxx RTA 5.0 fl oz. + Cruiser 1.28 | 0-0-60 | 29.4 | bcde | 43.1 | bcde |
| fl oz) ² | | | | | |
| 19. Treatment 2 + calcium formate 12.0 oz | 0-0-60 | 16.8 | efghi | 40.2 | cdefg |
| 20. Treatment 2 + calcium lactate 12.0 oz | 0-0-60 | 19.7 | defgh | 43.3 | bcde |
| 21. Treatment 2 + calcium nitrate 3.0 oz | 0-0-60 | 24.3 | cdef | 44.6 | bcde |
| 22. Treatment 2 + calcium salicylate 6.0 oz | 0-0-60 | 25.5 | bcdef | 45.7 | bcde |
| 23. Treatment 2 + calcium nitrate 1 lb N/acre, IF*** | 0-0-60 | 13.2 | hi | 29.5 | fghi |
| 24. Treatment 2 + calcium nitrate 2 lb N/acre, IF*** | 0-0-60 | 11.1 | i | 26.4 | ghi |

| | | |
|---|---|---|
| Prob. > F | <0.0001 | <0.0001 |

Emergence (%)

| Basic Treatment | 13 June | 14 June |
|---|---|---|
| 1. Treatment 1 (Cruiser 1.28 fl oz) ¹ | 26.7 a | 48.3 a |
| 2. Treatment 2 (ApronMaxx RTA 5.0 fl oz. + Cruiser 1.28 fl oz) ² | 30.3 a | 50.6 a |
| 3. Treatment 2 + calcium formate 12.0 oz | 25.4 a | 45.7 a |
| 4. Treatment 2 + calcium lactate 12.0 oz | 29.7 a | 49.0 a |
| 5. Treatment 2 + calcium nitrate 3.0 oz | 30.5 a | 50.1 a |
| 6. Treatment 2 + calcium salicylate 6.0 oz | 29.2 a | 52.5 a |
| 7. Treatment 2 + calcium nitrate 1 lb N/acre, IF*** | 18.0 b | 35.5 b |
| 8. Treatment 2 + calcium nitrate 2 lb N/acre, IF*** | 11.0 c | 23.6 c |
| Prob. > F | <0.0001 | <0.0001 |

Emergence (%)

| Potash Treatment | 13 June | 14 June |
|---|---|---|
| A. none | 30.7 a | 49.4 a |
| B. 0-0-60 (muriate of potash) | 20.6 b | 40.0 b |
| C. 0-0-50 (sulfate of potash) | 24.0 ab | 43.8 ab |
| Prob. > F | 0.0026 | 0.0374 |

*Values are the least square means. Means in the same column followed by the same letter are not significantly different based on SAS Proc GLIMMIX analyses of arcsin transformed data.
**0-0-50 = potassium sulfate (K₂SO₄); 0-0-60 = potassium chloride (KCl) or muriate of potash.
***IF = in-furrow.
¹ This is a common soybean seed treatment insecticide.
² This is a combination seed treatment (two fungicides + an insecticide) commonly used on soybeans.

TABLE 16
Effect of treatments (seed, in-furrow fertilizer, and potash form) on plant stand.*

| Seed & In-furrow Treatments | Potash | Plant stand (%) | | | | | |
|---|---|---|---|---|---|---|---|
| (rate product/100 lb seed) | treatment** | 25-26 June | | 16-17 July | | 6-8 August | |
| 1. Treatment 1 (Cruiser 1.28 fl oz) ¹ | none | 82.7 | abc | 73.3 | abc | 68.2 | abcdef |
| 2. Treatment 2 (ApronMaxx RTA 5.0 fl oz. + Cruiser | none | 80.0 | abcd | 77.5 | ab | 75.1 | ab |
| 1.28 fl oz) ² | | | | | | | |
| 3. Treatment 2 + calcium formate 12.0 oz | none | 79.8 | abcde | 72.7 | abc | 67.8 | abcdef |
| 4. Treatment 2 + calcium lactate 12.0 oz | none | 87.1 | a | 79.4 | a | 72.9 | abcd |
| 5. Treatment 2 + calcium nitrate 3.0 oz | none | 82.8 | abcd | 80.2 | a | 72.3 | abcde |
| 6. Treatment 2 + calcium salicylate 6.0 oz | none | 82.0 | abcd | 75.2 | ab | 67.7 | abcdef |
| 7. Treatment 2 + calcium nitrate 1 lb N/acre, IF*** | none | 78.4 | bcde | 71.9 | abc | 65.6 | cdef |
| 8. Treatment 2 + calcium nitrate 2 lb N/acre, IF*** | none | 60.1 | gh | 52.0 | e | 46.5 | h |
| 9. Treatment A (Cruiser 1.28 fl oz) | 0-0-50 | 73.7 | cdef | 69.3 | bc | 64.5 | def |
| 10. Treatment 2 (ApronMaxx RTA 5.0 fl oz. + Cruiser | 0-0-50 | 79.3 | abcde | 75.5 | ab | 67.4 | abcdef |
| 1.28 fl oz) | | | | | | | |
| 11. Treatment 2 + calcium formate 12.0 oz | 0-0-50 | 72.5 | cdef | 73.8 | ab | 70.4 | abcdef |
| 12. Treatment 2 + calcium lactate 12.0 oz | 0-0-50 | 83.4 | ab | 73.2 | abc | 71.5 | abcde |
| 13. Treatment 2 + calcium nitrate 3.0 oz | 0-0-50 | 77.5 | bcde | 71.3 | abc | 64.8 | def |
| 14. Treatment 2 + calcium salicylate 6.0 oz | 0-0-50 | 76.9 | bcde | 77.7 | ab | 74.3 | abc |
| 15. Treatment 2 + calcium nitrate 1 lb N/acre, IF*** | 0-0-50 | 71.9 | defg | 71.1 | abc | 63.3 | ef |
| 16. Treatment 2 + calcium nitrate 2 lb N/acre, IF*** | 0-0-50 | 59.9 | h | 55.8 | de | 53.3 | gh |
| 17. Treatment A (Cruiser 1.28 fl oz) | 0-0-60 | 76.6 | bcde | 74.2 | ab | 69.1 | abcdef |
| 18. Treatment 2 (ApronMaxx RTA 5.0 fl oz. + Cruiser | 0-0-60 | 76.6 | bcde | 72.8 | abc | 67.4 | abcdef |
| 1.28 fl oz) | | | | | | | |
| 19. Treatment 2 + calcium formate 12.0 oz | 0-0-60 | 76.5 | bcde | 69.2 | bc | 68.1 | abcdef |
| 20. Treatment 2 + calcium lactate 12.0 oz | 0-0-60 | 78.6 | bcde | 72.2 | abc | 66.1 | bcdef |
| 21. Treatment 2 + calcium nitrate 3.0 oz | 0-0-60 | 79.1 | bcde | 70.5 | abc | 66.0 | bcdef |
| 22. Treatment 2 + calcium salicylate 6.0 oz | 0-0-60 | 77.6 | bcde | 76.8 | ab | 75.8 | a |
| 23. Treatment 2 + calcium nitrate 1 lb N/acre, IF*** | 0-0-60 | 70.4 | efgh | 64.0 | cd | 61.1 | fg |
| 24. Treatment 2 + calcium nitrate 2 lb N/acre, IF*** | 0-0-60 | 61.6 | fgh | 57.3 | de | 53.1 | gh |

| | | | |
|---|---|---|---|
| Prob. > F | <0.0001 | <0.0001 | <0.0001 |

| | Plant stand (%) | | | | | |
|---|---|---|---|---|---|---|
| Basic Treatment | 25-26 June | | 16-17 July | | 6-8 August | |
| 1. Treatment 1 (Cruiser 1.28 fl oz) ¹ | 77.3 | bc | 71.6 | ab | 66.6 | bc |
| 2. Treatment 2 (ApronMaxx RTA 5.0 fl oz. + Cruiser 1.28 fl oz) ² | 78.4 | abc | 75.4 | a | 70.4 | ab |
| 3. Treatment 2 + calcium formate 12.0 oz | 76.4 | bc | 71.9 | ab | 68.7 | abc |
| 4. Treatment 2 + calcium lactate 12.0 oz | 83.0 | a | 75.3 | a | 70.2 | ab |
| 5. Treatment 2 + calcium nitrate 3.0 oz | 80.1 | ab | 74.0 | ab | 67.6 | abc |
| 6. Treatment 2 + calcium salicylate 6.0 oz | 79.1 | ab | 76.4 | a | 72.3 | a |
| 7. Treatment 2 + calcium nitrate 1 lb N/acre, IF*** | 73.7 | c | 69.4 | b | 63.7 | c |
| 8. Treatment 2 + calcium nitrate 2 lb N/acre, IF*** | 60.2 | d | 55.2 | c | 51.4 | d |

| | | | |
|---|---|---|---|
| Prob. > F | <0.0001 | <0.0001 | <0.0001 |

| | Plant stand (%) | | |
|---|---|---|---|
| Potash Treatment | 25-26 June | 16-17 July | 6-8 August |
| A. none | 79.9 a | 73.1 a | 67.2 a |
| B. 0-0-60 (muriate of potash) | 74.6 b | 69.5 a | 65.8 a |
| C. 0-0-50 (sulfate of potash) | 73.7 b | 70.8 a | 66.1 a |
| Prob. > F | 0.0336 | 0.3193 | 0.7651 |

*Values are the least square means. Means in the same column followed by the same letter are not significantly different based on SAS Proc GLIMMIX analyses of arcsin transformed data.
**0-0-50 = potassium sulfate (K₂SO₄); 0-0-60 = potassium chloride (KCl) or muriate of potash
***IF = in-furrow
¹ This is a common soybean seed treatment insecticide.
² This is a combination seed treatment (two fungicides + an insecticide) commonly used on soybeans.

TABLE 17
Effect of treatments (seed, in-furrow fertilizer, and potash form) on plant growth.*

| Seed & In-furrow Treatments | Potash | Leaflet^{§} length | Plant height (cm) | | |
|---|---|---|---|---|---|
| (rate product/100 lb seed) | treatment** | (cm) | 18 July | 15-16 August | |
| 1. Treatment 1 (Cruiser 1.28 fl oz) ¹ | none | 2.7 a | 35.6 a | 98.1 | bcd |
| 2. Treatment 2 (ApronMaxx RTA 5.0 fl oz. + Cruiser | none | 3.1 a | 38.4 a | 99.7 | bcd |
| 1.28 fl oz) ² | | | | | |
| 3. Treatment 2 + calcium formate 12.0 oz | none | 3.1 a | 37.3 a | 99.8 | bcd |
| 4. Treatment 2 + calcium lactate 12.0 oz | none | 3.1 a | 38.4 a | 100.7 | bcd |
| 5. Treatment 2 + calcium nitrate 3.0 oz | none | 3.1 a | 38.1 a | 109.4 | a |
| 6. Treatment 2 + calcium salicylate 6.0 oz | none | 2.7 a | 38.1 a | 103.1 | b |
| 7. Treatment 2 + calcium nitrate 1 lb N/acre, IF*** | none | 2.7 a | 36.4 a | 100.3 | bcd |
| 8. Treatment 2 + calcium nitrate 2 lb N/acre, IF*** | none | 2.4 a | 33.0 a | 95.7 | cd |
| 9. Treatment 1 (Cruiser 1.28 fl oz) ¹ | 0-0-50 | 2.8 a | 36.7 a | 99.7 | bcd |
| 10. Treatment 2 (ApronMaxx RTA 5.0 fl oz. + Cruiser | 0-0-50 | 2.7 a | 37.5 a | 97.5 | bcd |
| 1.28 fl oz) ² | | | | | |
| 11. Treatment 2 + calcium formate 12.0 oz | 0-0-50 | 2.7 a | 37.5 a | 99.8 | bcd |
| 12. Treatment 2 + calcium lactate 12.0 oz | 0-0-50 | 2.7 a | 36.2 a | 99.6 | bcd |
| 13. Treatment 2 + calcium nitrate 3.0 oz | 0-0-50 | 2.9 a | 36.0 a | 97.9 | bcd |
| 14. Treatment 2 + calcium salicylate 6.0 oz | 0-0-50 | 3.0 a | 37.5 a | 99.4 | bcd |
| 15. Treatment 2 + calcium nitrate 1 lb N/acre, IF*** | 0-0-50 | 2.6 a | 35.2 a | 101.7 | bcd |
| 16. Treatment 2 + calcium nitrate 2 lb N/acre, IF*** | 0-0-50 | 2.4 a | 36.0 a | 96.8 | cd |
| 17. Treatment 1 (Cruiser 1.28 fl oz) ¹ | 0-0-60 | 2.6 a | 36.2 a | 102.0 | bc |
| 18. Treatment 2 (ApronMaxx RTA 5.0 fl oz. + Cruiser | 0-0-60 | 2.6 a | 37.2 a | 100.9 | bcd |
| 1.28 fl oz) ² | | | | | |
| 19. Treatment 2 + calcium formate 12.0 oz | 0-0-60 | 2.6 a | 37.2 a | 99.2 | bcd |
| 20. Treatment 2 + calcium lactate 12.0 oz | 0-0-60 | 2.6 a | 36.4 a | 98.2 | bcd |
| 21. Treatment 2 + calcium nitrate 3.0 oz | 0-0-60 | 2.8 a | 36.1 a | 100.3 | bcd |
| 22. Treatment 2 + calcium salicylate 6.0 oz | 0-0-60 | 2.4 a | 36.5 a | 100.4 | bcd |
| 23. Treatment 2 + calcium nitrate 1 lb N/acre, IF*** | 0-0-60 | 2.4 a | 36.4 a | 95.9 | d |
| 24. Treatment 2 + calcium nitrate 2 lb N/acre, IF*** | 0-0-60 | 2.4 a | 36.2 a | 98.6 | bcd |

| | | | |
|---|---|---|---|
| Prob. > F | 0.0556 | 0.2942 | 0.0415 |

| | Leaflet length | Plant height (cm) | | |
|---|---|---|---|---|
| Basic Treatment | (cm) | 18 July | | 15-16 August |
| 1. Treatment 1 (Cruiser 1.28 fl oz) ² | 2.7 ab | 36.0 | c | 99.3 a |
| 2. Treatment 2 (ApronMaxx RTA 5.0 fl oz. + Cruiser 1.28 fl oz) ² | 2.8 ab | 37.7 | a | 99.5 a |
| 3. Treatment 2 + calcium formate 12.0 oz | 2.8 ab | 37.3 | a | 99.3 a |
| 4. Treatment 2 + calcium lactate 12.0 oz | 2.8 ab | 37.1 | abc | 100.0 a |
| 5. Treatment 2 + calcium nitrate 3.0 oz | 2.9 a | 36.8 | abc | 102.8 a |
| 6. Treatment 2 + calcium salicylate 6.0 oz | 2.7 ab | 37.3 | ab | 100.7 a |
| 7. Treatment 2 + calcium nitrate 1 lb N/acre, IF*** | 2.6 bc | 36.1 | bc | 99.3 a |
| 8. Treatment 2 + calcium nitrate 2 lb N/acre, IF*** | 2.4 c | 36.1 | bc | 99.3 a |

| | | | |
|---|---|---|---|
| Prob. > F | 0.0134 | 0.0264 | 0.1365 |

| | |
|---|---|
| Leaflet length | Plant height (cm) |

| Potash Treatment | (cm) | 18 July | 15-16 August |
|---|---|---|---|
| A. none | 2.9 a | 37.2 a | 101.1 a |
| B. 0-0-60 (muriate of potash) | 2.6 b | 36.5 a | 99.2 a |
| C. 0-0-50 (sulfate of potash) | 2.7 ab | 36.6 a | 99.1 a |
| Prob. > F | 0.0125 | 0.3808 | 0.2813 |

*Values are the least square means. Means in the same column followed by the same letter are not significantly different based on SAS Proc GLIMMIX analyses of arcsin transformed data.
**0-0-50 = potassium sulfate (K₂SO₄); 0-0-60 = potassium chloride (KCl) or muriate of potash.
***IF = in-furrow;
^{§}length of the center leaflet of the first trifoliolate leaf (measures differences in seedling vigor).
¹ This is a common soybean seed treatment insecticide.
² This is a combination seed treatment (two fungicides + an insecticide) commonly used on soybeans.

TABLE 18
Effect of treatments (seed, in-furrow fertilizer, and potash form) on soybean yield.*

| Seed & In-furrow Treatments | Potash | Percent | Test weight | | Yield | |
|---|---|---|---|---|---|---|
| (rate product/100 lb seed) | treatment** | water | (lb/bu) | | (bu/A) | |
| 1. Treatment 1 (Cruiser 1.28 fl oz) ¹ | none | 11.1 a | 58.22 | defgh | 51.9 | abcd |
| 2. Treatment 2 (ApronMaxx RTA 5.0 fl oz. + Cruiser 1.28 | none | 11.0 a | 58.33 | abcde | 52.3 | ab |
| fl oz) ² | | | | | | |
| 3. Treatment 2 + calcium formate 12.0 oz | none | 11.2 a | 58.18 | efgh | 50.0 | abcdefg |
| 4. Treatment 2 + calcium lactate 12.0 oz | none | 10.9 a | 58.34 | abcde | 52.3 | a |
| 5. Treatment 2 + calcium nitrate 3.0 oz | none | 11.1 a | 58.22 | cdefgh | 52.9 | a |
| 6. Treatment 2 + calcium salicylate 6.0 oz | none | 10.8 a | 58.46 | a | 48.8 | cdefg |
| 7. Treatment 2 + calcium nitrate 1 lb N/acre, IF*** | none | 11.1 a | 58.23 | cdefgh | 47.8 | fgh |
| 8. Treatment 2 + calcium nitrate 2 lb N/acre, IF*** | none | 10.9 a | 58.34 | abcde | 45.0 | i |
| 9. Treatment 1 (Cruiser 1.28 fl oz) ¹ | 0-0-50 | 10.8 a | 58.43 | ab | 48.9 | bcdefg |
| 10. Treatment 2 (ApronMaxx RTA 5.0 fl oz. + Cruiser 1.28 | 0-0-50 | 11.0 a | 58.27 | bcdef | 50.3 | abcdefg |
| fl oz) ² | | | | | | |
| 11. Treatment 2 + calcium formate 12.0 oz | 0-0-50 | 11.1 a | 58.24 | cdefg | 51.3 | abcdef |
| 12. Treatment 2 + calcium lactate 12.0 oz | 0-0-50 | 11.3 a | 58.11 | fgh | 51.6 | abcde |
| 13. Treatment 2 + calcium nitrate 3.0 oz | 0-0-50 | 11.0 a | 58.25 | cdefg | 47.8 | ghi |
| 14. Treatment 2 + calcium salicylate 6.0 oz | 0-0-50 | 11.1 a | 58.21 | defgh | 52.1 | abc |
| 15. Treatment 2 + calcium nitrate 1 lb N/acre, IF*** | 0-0-50 | 10.9 a | 58.36 | abcd | 51.3 | abcde |
| 16. Treatment 2 + calcium nitrate 2 lb N/acre, IF*** | 0-0-50 | 10.9 a | 58.39 | abc | 47.8 | ghi |
| 17. Treatment 1 (Cruiser 1.28 fl oz) ¹ | 0-0-60 | 11.3 a | 58.06 | h | 48.8 | defg |
| 18. Treatment 2 (ApronMaxx RTA 5.0 fl oz. + Cruiser 1.28 | 0-0-60 | 11.0 a | 58.32 | abcde | 50.4 | abcdefg |
| fl oz) ² | | | | | | |
| 19. Treatment 2 + calcium formate 12.0 oz | 0-0-60 | 11.0 a | 58.31 | abcde | 50.4 | abcdefg |
| 20. Treatment 2 + calcium lactate 12.0 oz | 0-0-60 | 11.2 a | 58.10 | gh | 48.7 | cdefg |
| 21. Treatment 2 + calcium nitrate 3.0 oz | 0-0-60 | 10.9 a | 58.32 | abcde | 51.2 | abcdef |
| 22. Treatment 2 + calcium salicylate 6.0 oz | 0-0-60 | 11.0 a | 58.33 | abcde | 50.3 | abcdefg |
| 23. Treatment 2 + calcium nitrate 1 lb N/acre, IF*** | 0-0-60 | 10.9 a | 58.33 | abcde | 53.0 | a |
| 24. Treatment 2 + calcium nitrate 2 lb N/acre, IF*** | 0-0-60 | 11.0 a | 58.27 | bcdef | 48.3 | efgh |

| | | | |
|---|---|---|---|
| Prob. > F | 0.3960 | <0.0001 | 0.0001 |

| | Percent | Test weight | Yield |
|---|---|---|---|
| Basic Treatment | water | (lb/bu) | (bu/A) |
| 1. Treatment 1 (Cruiser 1.28 fl oz) ¹ | 11.08 a | 58.23 bc | 49.7 b |
| 2. Treatment 2 (ApronMaxx RTA 5.0 fl oz. + Cruiser 1.28 fl oz) ² | 10.95 a | 58.32 ab | 51.7 a |
| 3. Treatment 2 + calcium formate 12.0 oz | 11.10 a | 58.22 bc | 50.3 ab |
| 4. Treatment 2 + calcium lactate 12.0 oz | 11.17 a | 58.17 c | 50.8 ab |
| 5. Treatment 2 + calcium nitrate 3.0 oz | 11.01 a | 58.28 ab | 50.5 ab |
| 6. Treatment 2 + calcium salicylate 6.0 oz | 10.97 a | 58.33 a | 50.0 ab |
| 7. Treatment 2 + calcium nitrate 1 lb N/acre, IF*** | 10.99 a | 58.30 ab | 50.5 ab |
| 8. Treatment 2 + calcium nitrate 2 lb N/acre, IF*** | 10.93 a | 58.34 a | 47.4 c |
| Prob. > F | 0.2578 | 0.0045 | 0.0019 |

| | Percent | Test weight | Yield |
|---|---|---|---|
| Potash Treatment | water | (lb/bu) | (bu/A) |
| A. none | 11.00 a | 58.30 a | 49.85 a |
| B. 0-0-60 (muriate of potash) | 11.04 a | 58.26 a | 50.14 a |
| C. 0-0-50 (sulfate of potash) | 11.03 a | 58.27 a | 50.42 a |
| Prob. > F | 0.8165 | 0.3892 | 0.7262 |

*Values are the least square means. Means in the same column followed by the same letter are not significantly different based on SAS Proc GLIMMIX analyses of arcsin transformed data.
**0-0-50 = potassium sulfate (K₂SO₄); 0-0-60 = potassium chloride (KCl) or muriate of potash.
***IF = in-furrow.
¹ This is a common soybean seed treatment insecticide.
² This is a combination seed treatment (two fungicides + an insecticide) commonly used on soybeans.

TABLE 19
Effects of potash treatment (rate) on soybean yield - by field.

| Potash | Field R7 | Field R8 |
|---|---|---|
| rate | Yield² | Yield |
| (lb/A) | (bu/A) | (bu/A) |
| 0 | 51.1 A | 53.0 A |
| 50 | 51.6 A | 51.3 A |
| 100 | 45.4 A | 46.9 A |
| 150 | 40.4 B | 56.3 A |
| Prob. > F | 0.0085 | NS^{#} |

^{#}NS = not significant (p > 0.05)

TABLE 20
Effects of experimental seed treatment supplements
on soybean yield - by field.

| | | Field R7 | | Field R8 |
|---|---|---|---|---|
| Seed treatment | | Yield² | | Yield |
| (rates/100 lb seed) | Rate | (bu/A) | | (bu/A) |
| 1. Base + 0.25 oz Calcium | 1X | 48.9 | AB | 49.6 A |
| salicylate | | | | |
| 2. Base + 0.50 oz Calcium | 2X | 50.8 | A | 54.4 A |
| salicylate | | | | |
| 3. Base + 0.75 oz Calcium | 3X | 45.8 | BCD | 50.9 A |
| salicylate | | | | |
| 4. Base + 0.50 oz Sodium | 1X | 48.9 | AB | 52.6 A |
| salicylate | | | | |
| 5. Base + 1.00 oz Sodium | 2X | 47.6 | ABC | 52.2 A |
| salicylate | | | | |
| 6. Base + 1.50 oz Sodium | 3X | 46.5 | BCD | 53.0 A |
| salicylate | | | | |

| | | | |
|---|---|---|---|
| 7. Distilled water | 43.1 | D | 52.2 A |
| 8. Cruiser 1.28 fl oz | 46.6 | BCD | 48.2 A |
| 9. Cruiser + Apron-Maxx (=“Base” for | 44.6 | CD | 52.4 A |
| treatments 1-6 (ApronMaxx RTA 5.0 fl | | | |
| oz. + Cruiser 1.28 fl oz)) | | | |
| 10. Base + Bio-Forge ST 2.0 oz | 48.6 | AB | 53.2 A |

| | | |
|---|---|---|
| Prob. > F | 0.0076 | NS^{#} |

^{#}NS = not significant (p > 0.05)
²Yields have been corrected to 60 lb soybeans/bu at 13.0% moisture.
Values are the means of either two replications of each potash treatment or eight replications of each seed treatment in each field.
Means in the same column followed by the same letter are not significantly different (p = 0.05).

The foregoing is illustrative of the present invention, and is not to be construed as limiting thereof. The invention is defined by the following claims, with equivalents of the claims to be included therein.

What is claimed is:

1. A method of controlling phytopathogenic diseases on seeds of useful plants, which comprises applying to the seeds a fungicidally effective amount of a salicylic acid or an agriculturally acceptable salt thereof, is applied to the seeds.

2. The method according to claim 1, comprising applying to the seeds a fungicidally effective amount of a plant propagation material protecting composition comprising the mixture, together with a suitable carrier.

3. The method according to claim 2, wherein said applying step comprises spraying or wetting the seeds with a liquid composition comprising the mixture, together with a suitable carrier.

4. The method according to claim 2, wherein said applying step comprises mixing the seeds with a solid composition comprising the mixture, together with a suitable carrier.

5. The method according to claim 2, wherein the plant propagation material protecting composition further comprises a water-soluble or water-dispersible film-forming polymer.

6. The method according to claim 1, wherein the salicylic acid or an agriculturally acceptable salt thereof is selected from the group consisting of calcium salicylate and sodium salicylate.

7. The method according to claim 1, wherein the plant is a dicot or a monocot.

8. The method according to claim 7, wherein the dicot is a soybean or a snap bean.

9. A seed treated with a plant propagation material protecting composition comprising a fungicidally effective amount of a salicylic acid or an agriculturally acceptable salt thereof, together with a suitable carrier.

10. The seeds according to claim 9, wherein said composition additionally comprises a coloring agent.

11. The seeds according to claim 9, wherein the salicylic acid or an agriculturally acceptable salt thereof is selected from the group consisting of calcium salicylate and sodium salicylate.

12. A method of treating a subject suffering from or susceptible to a fungal disease, wherein the method comprises administering to said subject an effective amount of a salicylic acid compound or an agriculturally acceptable salt thereof.

13. The method according to claim 12, wherein the salicylic acid or an agriculturally acceptable salt thereof is selected from the group consisting of calcium salicylate and sodium salicylate.

14. A method of controlling a plant pathogen comprising administering a composition comprising an effective amount of a salicylic acid or an agriculturally acceptable salt thereof to a seed, to a foliar surface of a plant, or to a locus of the plant or seed.

15. The method according to claim 14, wherein the salicylic acid or an agriculturally acceptable salt thereof is selected from the group consisting of calcium salicylate and sodium salicylate.

16. The method according to claim 14, further comprising adding at least one additional fungicide, herbicide, or insecticide, bactericide, acaracide, nematicide, plant growth regulator, fertilizer, or plant nutrients to said composition.

17. The method according to claim 14, wherein said composition additionally comprises a coloring agent.

18. The method according to claim 14, wherein the plant or seed of the plant is a monocot or dicot.

19. The method according to claim 18, wherein the dicot is a soybean or a snap bean.

20. A method for improving the health or propagation of a plant or seed of a plant by applying an effective amount of a composition containing at least one of sodium salicylate or calcium salicylate.

21. The method according to claim 20, further comprising adding at least one additional fungicide, herbicide, or insecticide, bactericide, acaracide, nematicide, plant growth regulator, fertilizer, or plant nutrients to said composition.

22. A method of increasing yield of a crop plant comprising applying to seeds of said crop plant a salicylic acid or an agriculturally acceptable salt thereof, planting said seeds and harvesting the crop produced by said crop plant.

23. The method according to claim 22, comprising applying to the seeds an effective amount of a plant propagation material protecting composition comprising the mixture, together with a suitable carrier.

24. The method according to claim 23, wherein said applying step comprises spraying or wetting the seeds with a liquid composition comprising the mixture, together with a suitable carrier.

25. The method according to claim 23, wherein said applying step comprises mixing the seeds with a solid composition comprising the mixture, together with a suitable carrier.

26. The method according to claim 23, wherein the plant propagation material protecting composition further comprises a water-soluble or water-dispersible film-forming polymer.

27. The method according to claim 22, wherein the salicylic acid or an agriculturally acceptable salt thereof is selected from the group consisting of calcium salicylate and sodium salicylate.

28. The method according to claim 22, wherein the plant is a dicot or a monocot.

29. The method according to claim 28, wherein the dicot is a soybean or a snap bean.
